(19) United States
(12) Patent Application Publication
(10) Pub. No.: US 2019/0295110 A1
(43) Pub. Date: Sep. 26, 2019

(54) PERFORMANCE ANALYTICS SYSTEM FOR SCRIPTED MEDIA

(71) Applicant: STORYFIT INC., Austin, TX (US)

(72) Inventors: Mark BESSEN, Austin, TX (US); Monica LANDERS, Austin, TX (US); Henrik KJALLBRING, Austin, TX (US); David O'BRIEN, Somerset, KY (US); Christen THOMPSON, North Charleston, SC (US); Jacob MINGUS, Cedar Park, TX (US); McArthur GILL, Austin, TX (US); Grace LIN, Austin, TX (US)

(21) Appl. No.: 16/440,721

(22) Filed: Jun. 13, 2019

Related U.S. Application Data
(63) Continuation-in-part of application No. 15/836,767, filed on Dec. 8, 2017.
(60) Provisional application No. 62/432,262, filed on Dec. 9, 2016.

(51) Int. Cl. G06Q 30/02; G06F 16/28; G06F 16/25; G06N 20/00

(52) U.S. Cl. CPC G06Q 30/0202; G06N 20/00; G06F 16/258; G06F 16/287

(57) ABSTRACT

A performance analytics system that provides tools for content insights and marketing analysis to an individual user or an individual partner. The system includes: an interactive subsystem component that allows for input of scripted content and associated data by users and partners, a data storage subsystem component that stores the scripted content data input by the users and the partners, and a performance analytics component programmed to process the input scripted content data to produce results and/or a recommendation for action to individual users or partners. The system applies similarity computations and displays the computed results pertaining to production details and a variety of features of the input scripted content.

This application is a continuation-in-part of U.S. patent application Ser. No. 15/836,767, filed Dec. 8, 2017, which Claims priority to U.S. Provisional Patent Application No. 62/432,262, filed Dec. 9, 2016. The entirety of all of the aforementioned applications is incorporated herein by reference.

### FIELD

The presently disclosed subject matter relates to content insight and marketing analysis of scripted media. In particular, the presently disclosed subject matter relates to ascertaining quantifiable attributes and patterns in scripted content across multiple sources and providing insights and evaluations to predict the market viability of that content.

### BACKGROUND

Conventional evaluation of scripted content in the entertainment industries and other content management companies relies on human ability to ingest, evaluate, and determine the quality and salability of the scripted content. Traditionally, such a vast amount of information has been difficult to collect and gather, or derive from the original media content using machine learning algorithms into one database to be processed by a complex system to be used for decision making. Moreover, conventional conclusions and decisions are often inaccurate because of the subjective and approximate techniques of evaluation. Inefficiency of the data processing has been another issue in the related field because, typically, the resulting information is compiled without the assistance of faster, scalable data-mining tools for text analysis.

From the commercial standpoint, substantial resources are presently wasted due to the retroactive decision making process. Namely, the existing content analysis processes that do use machine learning and natural language processing apply their data science to trailing data and in post-production stages of content after an acquisition has been made. Thus, any lessons learned are applied in the future, after the expenses have already been accrued and the investment decisions have already been made. Additionally, content management is done in isolation from industry-wide analysis of competitors where an aggregate of the data does not exist, limiting the ability to measure the quality of content against a comparable data set.

In light of the discussed inadequacies of the existing techniques, there is a need for a tool that is capable of enriching metadata, and deriving content insights for a variety of scripted content data, and a system that allows for the gathered data to be processed in an integrated platform in order to improve and customize the decisions regarding acquisitions, content investment, and other decisions related to the viability of the pertinent content.

### SUMMARY

The presently disclosed subject matter relates to an analytics tool that optimizes performance prediction of scripted content to an individual user or an individual partner. In one embodiment, a networked computerized system for analyzing scripted content comprises: a plurality of networked, standalone, programmed devices; and a network that connects the networked, standalone, programmed devices; wherein each of the plurality of networked, standalone, programmed devices includes: an interactive subsystem component that allows for input of scripted content data by at least one user or at least one partner; a data storage subsystem component that stores the scripted content data input by the at least one user or at least one partner; and a performance analytics component programmed to process the input scripted content data to produce a predictive or descriptive recommendation for analysis or for action to the at least one user or at least one partner, wherein the performance analytics component includes a plurality of similarity computation algorithms.

The interactive subsystem component may output the recommendation for analysis or for action to the at least one user or at least one partner. The recommendation for action may occur at a pre-production or pre-acquisition stage of the scripted content. The processing of the input scripted content data may include sentiment identification and categorization. The sentiment identification and categorization may comprise emotion extraction from the content data. The sentiment identification and categorization may comprise tone details extraction from the content data. Narrative characteristics and plot types may be derived from the identified and categorized sentiment. An interactive subsystem component may output a visual diagram of results presenting the identified and categorized sentiment.

The processing of the input scripted content data may include topic modeling that extracts topics from the scripted content data. The topic models may be visually represented in a map. The extracted topics may be mapped to their corresponding keywords. The data storage subsystem component may maintain a database of keywords and metadata. The performance analytics component may be programmed to track performance of the keywords. The performance analytics component may be programmed to iteratively update the keywords based on the keyword performance. The performance analytics component may be further programmed to prepare the input scripted content data for processing by performing the following steps: dividing the content data into logical units of storage, adding the divided content data to the data storage subsystem component, converting the divided content data into an extractable file form, extracting metadata from the converted content data, and storing the extracted metadata in a database.

The performance analytics component may be programmed to process the input scripted content data by natural language processing. The performance analytics component may be further programmed to tokenize the scripted content data using an internal dictionary of terms prior to tagging. The performance analytics component may be further programmed to create the internal directory from terms derived from a corpus of scripted content. The data storage subsystem component may include a dictionary of tags correlating sentiments to natural language of the content data, wherein the sentiment identification and categorization includes using the dictionary of tags to map scripted content units to a corresponding sentiment value.

The preparation of the input scripted content data for processing may further include programming the performance analytics component to perform stylometry analysis on logical units of storage of the scripted content data. Output of the stylometry analysis may include at least of one of the following: tone, pacing, and authorial attributes of the processed content data. The stylometry analysis may include readability analysis of the scripted content data. The performance analytics component may be programmed to extract at least one plot arc from the scripted content data. The at least one extracted plot arc may be categorized and organized based on archetypical plot types. The performance analytics component may be programmed to enrich the database of metadata and keywords by ingesting and processing the input scripted content data.

The similarity computation algorithms may determine comparability based on based on features of the scripted content. Additionally, the similarity computation algorithms may determine comparability based on based on production details. The performance analytics component may include a plurality of machine learning algorithms, wherein results computed by the machine learning algorithms may be used as input for the similarity computation algorithms.

In another embodiment, a networked computerized method for analyzing scripted content comprises: inputting scripted content data by at least one user or at least one partner by using an interactive subsystem component; storing the scripted content data input by the at least one user or at least one partner by using a data storage subsystem component; and processing the input scripted content data to produce a predictive or descriptive recommendation for analysis or for action to the at least one user or at least one partner by using a performance analytics component, wherein the performance analytics component includes a plurality of similarity computation algorithms.

The similarity computation algorithms may determine comparability based on at least one of the following: setting, character, style, topics, sentiment, budget, and cast. The method may further comprise preparing the input scripted content for processing by performing the following steps: dividing the content data into logical units of storage, adding the divided content data to the data storage subsystem component, converting the divided content data into an extractable file form, extracting metadata from the converted content, and storing the extracted metadata in a database. The method may further comprise migrating the prepared scripted content from a customer-facing storage system to an internal database.

In yet another embodiment, a machine learning method for analyzing scripted content comprises: inputting scripted content data by at least one user or at least one partner by using an interactive subsystem component; storing the scripted content data input by the at least one user or at least one partner by using a data storage subsystem component; and processing the input scripted content data to produce a predictive or descriptive recommendation for analysis or for action to the at least one user or at least one partner by using a performance analytics component, wherein the performance analytics component includes a plurality of machine learning algorithms.

The plurality of machine learning algorithms may comprise neural network algorithms. The performance analytics component may include a plurality of similarity computation algorithms, and wherein results computed by the machine learning algorithms are used as input for the similarity computation algorithms. The performance analytics component may be programmed to extract metadata from the scripted content and input the extracted metadata in the plurality of machine learning algorithms.

In one example, a decision support system for analyzing scripted content comprises: an interactive subsystem component that allows for input of scripted content data by at least one user or at least one partner; a data storage subsystem component that stores the scripted content data input by the at least one user or at least one partner; and a performance analytics component programmed to process the input scripted content data to produce a predictive or descriptive recommendation for analysis or for action to the at least one user or at least one partner, wherein the performance analytics component includes a plurality of similarity computation algorithms.

In another example, a data processing method for processing scripted content comprises: inputting scripted content data by at least one user or at least one partner by using an interactive subsystem component; storing the scripted content data input by the at least one user or at least one partner by using a data storage subsystem component; and processing the input scripted content data to produce a predictive or descriptive recommendation for analysis or for action to the at least one user or at least one partner by using a performance analytics component, wherein the performance analytics component includes a plurality of similarity computation algorithms.

### BRIEF DESCRIPTION OF THE DRAWINGS

FIG. 1 shows an example of an operational overview flowchart of the performance analytics system.

FIG. 2 shows an example of an overview of the performance analytics system showing various points of user interaction with the system.

FIG. 3 shows an example block diagram illustrating a computing system for implementing a performance analytics system and results.

FIG. 4 shows an example flow chart of a similarity comparison engine.

FIG. 5 shows an example screenplay file used as input for pre-processing.

FIG. 6 shows an example interactive script manager.

FIG. 7A shows an example structured format of a pre-processed screenplay.

FIG. 7B shows an example structured format of a pre-processed screenplay.

FIG. 7C shows an example structured format of a pre-processed screenplay.

FIG. 7D shows an example data storage operation flowchart for screenplay content.

FIG. 8A shows an example similarity calculator.

FIG. 8B shows an example similarity calculator.

FIG. 9A shows an example of scores computed by similarity calculators.

FIG. 9B shows an example of scores computed by similarity calculators for each unique feature.

FIG. 10A shows an example dashboard that provides visualization of comps for scripted content.

FIG. 10B shows an example dashboard that allows comps filtering.

FIG. 10C shows an example comps dashboard that concentrates on one comp from a list.

FIG. 11A shows an example of books keyword generation flowchart.

FIG. 11B shows an example keyword editor quality control interface.

FIG. 11C shows an example output of the keyword quality control process.

FIG. 11D shows an example flow chart of book metadata and content feature extraction.

FIG. 12A shows an example predicted ratings display for the selected content.

FIG. 12B shows an example genre prediction display for the selected content.

FIG. 12C shows an example content advisories prediction display for the selected content.

FIG. 12D shows an example dashboard presenting information about characters in a screenplay.

FIG. 12E shows an example diagram showing mutual relationships among characters in a screenplay.

FIG. 12F shows an example dashboard displaying sentiments present within a processed screenplay.

FIG. 12G shows an example display of structural and stylistic features of a processed content.

FIG. 12H shows an example dashboard of top stand-out scene locations in a processed content.

FIG. 12I shows an example dashboard presenting “corpus comparison” analysis of a screenplay.

FIG. 12J shows an example file that includes direct comparison among multiple characters.

FIG. 12K shows an example display of features over narrative time.

FIG. 13A shows an example display of percent dialogue per chapter for a selected book.

FIG. 13B shows an example display of a protagonist's overall emotion in a selected book.

FIG. 13C shows an example display of a protagonist's needs in a selected book.

FIG. 13D shows an example display of a protagonist's personality traits in a selected book.

FIG. 13E shows an example display of a protagonist's values in a selected book.

FIG. 14A shows an example display of topics regarding features being discussed in a selected screenplay.

FIG. 14B shows an example display of events, actions, and/or movements in a selected screenplay.

FIG. 14C shows an example display of character related topics in a selected screenplay.

FIG. 14D shows an example display of setting topics in a selected screenplay.

FIG. 15A shows an example display of results of a prediction market viability model.

FIG. 15B shows an example display of results of a style overview model.

FIG. 15C shows an example display of results of a grammar analysis model.

### DETAILED DESCRIPTION

The presently disclosed subject matter provides a system for predicting, analyzing and diagnosing results on market viability, audience metrics, and content insights for scripted media. The system is preferably a decision support tool, but is not intended to be so limited; rather, it is contemplated that other tools or means that enable scripted media market analysis are within the scope of the presently disclosed subject matter. The described system may process a piece of scripted media and return features, analysis, overviews, comparisons with individual titles, comparisons with subset of a corpus, or comparisons with an entire corpus. The system may also provide predicted market viability. Features may be extracted from the texts using machine learning and text mining techniques. Features include but are not limited to the settings (i.e., where a text takes place), plot, sentiment, tone, language usage, style, or character analysis (i.e., descriptions of protagonists or other characters).

The presently disclosed subject matter will be described in connection with one or more computing systems for purpose of illustration of how the acquired data may be processed. It is intended that the presently disclosed subject matter may be used with any system capable of performing scripted media market analysis. Moreover, the presently disclosed subject matter may be applied in any remote systems, for example, through wireless communication.

Examples of scripted media market analysis entities include, but are not limited to, publishing organizations, filming studios, television stations, gaming developers, music studios and distributors and other storytelling media. The presently disclosed subject matter may also be used in connection with online websites, private or public, including social media, for example. The gathered scripted content data may be remotely uploaded and analyzed and the feedback may be provided to the user.

One of the objectives of the present invention is to ascertain quantifiable attributes and patterns in scripted content across multiple sources. Some of the sources of content may be publishing, film, gaming, music, documentation, or any other scripted media considered suitable. The performance analytics system component may process the data acquired by the content courses and provide insights and evaluations to predict the market viability of the content.

Simultaneously, the performance analytics system component may compile and display actionable data for literary agents, publishers, producers and other content management and distribution companies. The results may be presented in the form of reports, dashboards, or raw data feeds for the purpose of being applied to acquisitions, content investment, marketing, and other decisions related to the viability of their content. The predictive results and content insights derived from the content may be delivered via a variety of content management tools and used as input.

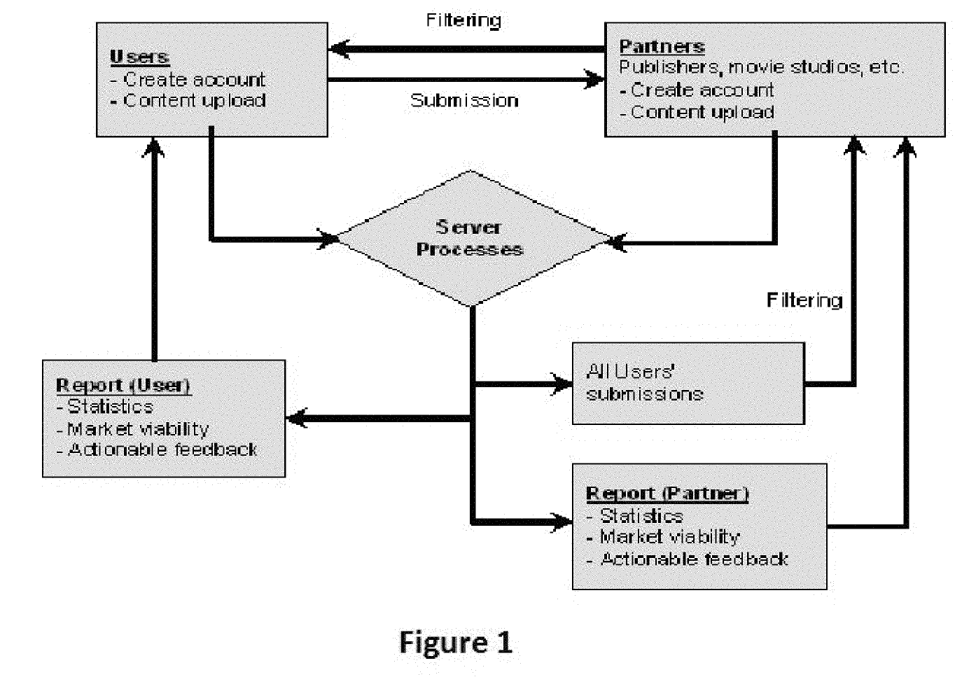

In one embodiment of the present invention shown in FIG. 1, a user may begin by signing up for the system via the Internet, for example, and may create an account. Next, the user may input, upload, connect, and via other means enter personal information into the system and set up the system to automatically pull the user's information and content from other systems and devices. The user's information may be provided via connections to devices or other information services considered appropriate. The user may subsequently upload content into the system. Next, the user may request a user report with feedback on market viability and content insights of the uploaded content.

In addition to the users, the performance analytics system may include partnering entities. The partners may register and each partner may self-select what type of partner they will be for interacting with the system. Some of the partner-types are book publishers, movie studios, gaming software producers, etc. The partners may be able to upload their own content for processing and receive reports with feedback. Further, the partners may be able to view users' supplied content by setting content preferences and to interact with users' submissions.

Another element of the performance analytics system may be server processes. The server processes may analyze content, create information, provide recommendations for users and partners, drive display interactions, and communicate with the user via numerous channels which drive reports and users' submissions. The communication channels may be email, SMS, display, IM, or any other techniques deemed suitable. The reports may be created for the users or for the partners, and each may include the statistical data, market viability, or actionable feedback.

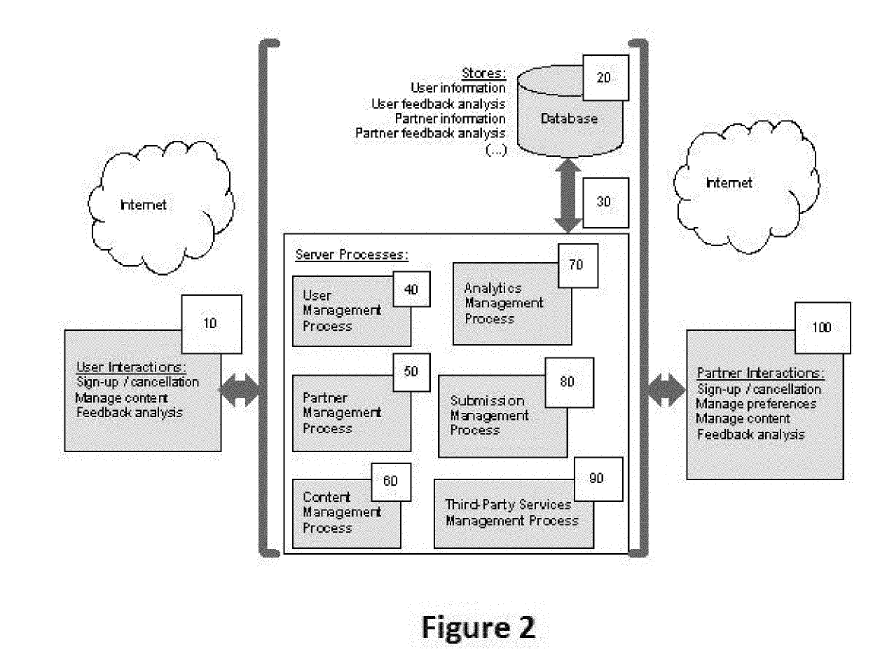

FIG. 2 provides a detailed view of the server processes and their interaction with the rest of the system. In the example illustrated in FIG. 2, internet users 10 and internet partners 100 interact with the system via secure communication channels. Server processes may be user management process 40, partner management process 50, content management process 60, analytics management process 70, submission management process 80, and third-party management process 90. The server processes, which may receive input from the users 10 and the partners 100, may interact with the database 20, accessed via a secure communications link 30 to store raw, intermediate, state, and finished data related to all aspects of the system, the users 10, or the partners 100.

The users 10 may interact with the rest of the system via secure communications links 30, input a variety of information, and connect their devices to the system. The connection may be established via simple account or via device registrations through downloading binary specific applications to their devices to allow data sharing and processing on such devices. The users 10 may gain both read and write access to the system for their use of the system in any other ways considered feasible.

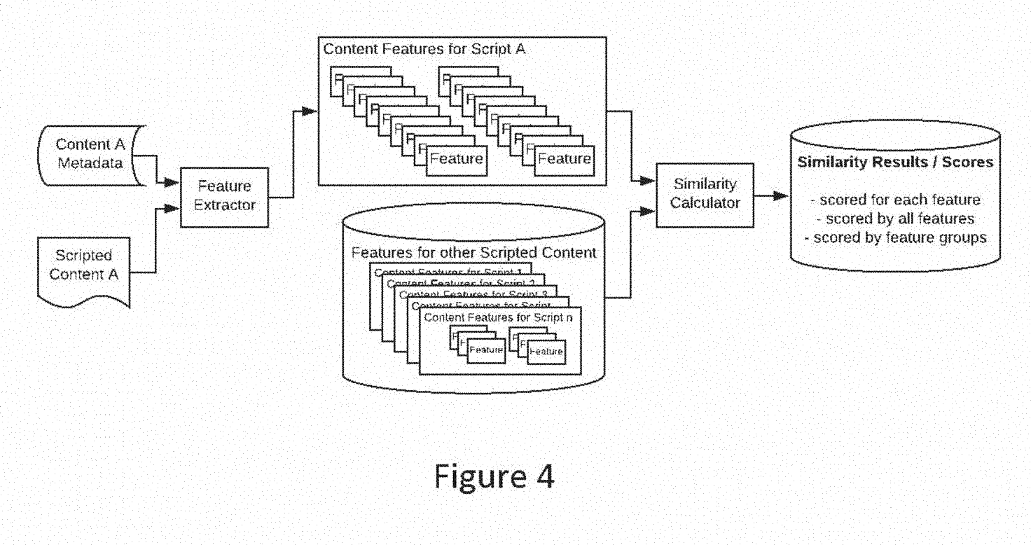

The content management process 60 may interact with one of multiple databases 20 via secure communication channels 30, which may store both the users' and the partners' information and other data, such as device and partner generated data, historical data, metadata, content, etc. One of the examples of content and metadata processing is shown in FIG. 4, discussed in detail below.

The user management process 40 may track user information, handle registration and account cancellation, control access to other server processes and partner access to user information, for example. Further, the user management process 40 may provide graphical displays of information for user interaction and tracking, etc. The user management process 40 may also enable the users 10 to participate in a user driven system which may enables the users 10 to directly document and curate user data directly.

The partner management process 50 may track partner information, handle registration and account cancellation, setting of preferences, control access to other server processes and user access to partner information. The partner management process 50 may also provide graphical displays of information for partner interaction and tracking. The partner management process 50 may also enable partner to participate in a partner driven system which may enable partners to interact with each other, and to directly document and curate users' content data.

The analytics management process 70 may provide automatic predictive analysis based on user or partner data, based on user or partner data trends, third-party processing information, user or partner self-reported information, and any other available data which could be used to make predictions for the users 10 or the partners 100 and supply feedback.

The third-party services management process 90 may provide access to the overall system via secure access channels through any number of methods including, but not limited to, web-based forms, programmatic access via restful APIs, SOAP, RPC, scripting access, etc. At the same time, the third-party services management process 90 may also provide secure access methods including key-based access to ensure the system remains secure and only authorized third-parties can gain access to the system.

The partner management process 50 may provide additional processing and analysis services by further analyzing partners' content data, providing comparative analysis. The comparison may be conducted between the users 10, the partners 100, other services, public databases and datasets, content, etc. In this manner, the system improves a process of analyzing the user data, the partner data, or the overall content. Content and feature comparison will be elaborated below with respect to FIG. 4.

Lastly, the submission management process 80 may allow the users 10 and the partners 100 to interact and share content/information with each other.

In another embodiment, specialized workflows could be added to extend the usefulness of the current platform into the editing process for the scripted content, thereby allowing the analytics to influence the editing process, for example. Further, unique algorithms may be developed based on unique buyer questions, such as the difference in scripts chosen by particular editors. The scripts may be chosen by particular imprints, led by a particular director, or any other influence that a buyer wants to review.

The performance analytics system may be introduced in schools or universities to review and analyze essays, dissertations, research papers, etc. Moreover, the system may be applied in business and government settings to review and analyze business proposals, memorandums, grant applications, legal documents, advertising copy, etc. The system may represent an extension to any story-based or creative expression that begins with text including but not limited to literary and theatrical review analysis, stage plays, musical lyrics, etc.

In multimedia gaming, the system may be used to analyze game mapping and storytelling, and to analyze computer language and coding across multiple languages, for example. The performance analytics system may extend the analysis of text across multiple languages (e.g. Spanish, French, Portuguese, German, etc.). The system may create new scripted media (original or inspired by existing works) targeting specific audience in educational, governmental, or commercial settings.

In one example, a user performs manuscript ingestion by adding book content to a database divided into logical units of storage such as labeled folders in a storage system, such as S3 buckets, via the file transfer protocol (FTP). The performance analytics system component may automatically pull down files (e.g., ePub or PDF files), convert the documents to a text file, store them in the database, extract metadata from them by using tools such as Calibre, for example, and store the metadata in the database. Files that do not have easily extractable text formats may be processed using Optical Character Recognition. Subsequently, the system may migrate the text from the customer-facing storage system, which may be an S3 bucket to an internal database, which may be an open source object-relational database system such as a relational, non-relational, or other database type system deemed appropriate.

The inserted text may be processed and analyzed by using natural language processing, or any other technique deemed suitable. In one example, the inserted text may be tokenized before being part-of-speech tagged. Next, specific words may be stemmed and lemmatized, and stopwords which are of lesser significance may be removed, thereby creating an internal dictionary. Accordingly, numerous documents may be created and modulated into appropriately sized units. The selection and the size of the units may be performed empirically, based on experimentation.

Once the analysis and processing is completed, the user's (or the writer's) emotion and sentiment within the content, or the particular topic within the content, may be identified and categorized. Accordingly, a proprietary dictionary may be used to tag the sentiment in the natural language processing sense, where each word in the original content/text is mapped to a particular “sentiment/emotion” value. In one embodiment, the tagging may be used for mapping sentiments over the course of the entire document, or the mapping can be performed only on a portion of the document, for example. A variety of libraries may be used to conduct a spell check and to correct for any grammatical errors, as well as for determination of the point of view, i.e., whether the statements are expressed in the first, second or third person.

The topics and themes may be extracted from the content of the documents using topic modeling. The modeling may produce an overall topic, or, in the alternative, different parts of the speech may be segregated and separately modeled using topic modeling. Once the topic models are formed, each or some of them may be labeled and visualized in a map, for example, or by any other visualization means considered appropriate. In one example, the extracted topics are mapped to specific keywords or phrases which correspond to the content. The text in the database may be processed stylometrically, i.e., number of sentences, lengths of individual paragraphs, or length of an entire document may be determined, as well as proprietary stylometic feature analyses. Stylometric analysis is not limited to these features, however, and includes other such as the tone, pacing, unique authorial attributes, and other features deemed suitable in assessing the “style” of a piece of scripted media.

Further, n-grams may be collected for each title to include words, letters, syllables, phonemes, etc., and readability indicators may be calculated. N-grams are derived from across the corpus of scripted media using proprietary phrase identification models. Some of the indicators may be reading scores, reading ease, Fleish-Kincaid, Coleman-Liau, or any other indices deemed suitable.

The analyzed text may be processed to extract the plot of the narrative of the content, and the plots may be organized and categorized into archetypical plot types. Moreover, named entities identified from the processed text may be recognized as their character names, or can be correlated with a geographic or topographic location, or can be ontologically categorized. A variety of natural language tools may be applied for the recognition and matching, one of such tools being the Watson NLP. Depending on the individual characteristics of an application, the application may be modularized or containerized by using a virtual machine, such as Docker virtual machine, for example.

The performance analytics system component may apply a database of book metadata and keywords. Lists of category-specific keywords may be obtained from publically available databases, provided by Amazon, for example. Each keyword may be mapped to a feature from a text ingested from book or scripted media content. Publically available lists and tags corresponding to scripted content, including but not limited to those on reader-supported sites like Goodreads for books, or view-supported like IMDb for scripts, may be mapped to content features to enhance keywords. Similar techniques may be used for scripted media other than books, including gathering publically available databases of movie and TV show information, including user-generated tags for that content.

In addition, metadata including reviews, descriptions, genres, wordclouds, etc., may be extracted from databases such as Google Books API, or any other database deemed appropriate. The performance analytics system component may collect search trend data and track trends over time, from databases such as Google trends, or similar databases and/or use keyword planners for suggested keywords for given topics, an exemplary planner being Google AdWords. The system may further incorporate industry best practices and relevant sales performance in order to input an internal set of keyword weights, based on the known market favorites.

Some techniques of accounting for market trends may include daily scraping of sales ranks, as well as metadata including description, reviews, prices, availability, etc., available by some of the major content providers, such as Amazon, for example. Another tracked criterion may be actual sales figures for books; sales figures will be provided by clients. Actual sales figures can be cross referenced with sales ranks to interpolate actual sales across all scraped titles.

The performance analytics system component may generate a matrix of all titles by all keywords and perform various regression techniques to highlight high-performing keywords, based on various criteria, such as best sales or page view performance. The system may then re-weight keywords across the entire corpus based on results of regressions and update the weights. This methodology may result in quarterly iteration on each title's keywords, where each book may be re-run through the system's processing pipeline to update its keywords.

The results may be output and delivered as a set of keywords per title up to a predetermined number of characters (e.g., 500). Moreover, the clients may receive a list of their keyword sets per title in an Excel format, or any other format deemed suitable. The system may further integrate keywords into existing Content Management Systems (CMS).

Turning to visualization, a keyword selection tool may categorize keywords based on criteria used for extraction, some of the criteria being topic, theme, sentiment, plot, etc. The keyword selection tool may allow a user to add keywords, tag keywords as relevant or not based on a number of factors, remove keywords undesired in the final set, or to re-order keywords based on the user's preference. The keyword selection tool may further track which keywords are removed or added to improve model accuracy moving forward or track keyword version histories for a given text/book. Data available on the web may be provided in the user interface to visualize a given title's descriptions, cover, shelves, etc., thereby making the keyword selection faster and easier. The keyword selection tool can be used either internally or external clients, in which case the user interface would be hosted on external servers, provided by Amazon Web Service, for example.

Regarding the usage of keywords by a publisher or a content delivery specialist, keywords can be added to the field marked “keywords” in a feed of a publishing protocol, such as ONIX, for example, by a publisher to be sent to book distributors like Amazon, Kobo, iBooks, Barnes & Noble, etc. Keywords can be used for publishers' websites to improve their book search engine optimization, or to libraries' records to improve discoverability and search. As a result, a user may own the keyword set to be used for book discovery projects, for example. Keywords can also be derived from other scripted media, including movie and TV scripts, and can be used to aid search optimization or to enrich the data available about a piece of content. In such cases, keywords are provided in the appropriate metadata format for the respective industry.

The performance analytics system component may generate a set of comps for a seed title, where seed titles may be compared to other titles, overall or in a given dataset, such as a dataset of all books from a certain publisher, for example. That is, the system can provide comparisons between a single piece of content and a broader subset of a corpus of scripted media, or to individual pieces of scripted media. The subset of a corpus may be provided by one of the partners, such as a hand-tagged selection of titles, or the subset may be defined by industry standards, such as commercial viability or genre label.

In another embodiment of the technology, the manuscript ingestion may be performed via the file transfer protocol (FTP), and the files may be automatically pulled down, converted to a text file, and stored in the database for comparison with other titles. As discussed above, the inserted text may be processed and analyzed by using natural language processing, and tokenized before being speech-tagged. Specific words may be stemmed and lemmatized, and numerous documents may be created and modulated into appropriately sized units. Once the analysis and processing is completed, the sentiment may be identified, categorized, and tagged based on a proprietary dictionary. The tagging may be used for mapping sentiments in order to facilitate comps optimization.

Compared topics may be extracted from the content of the documents and modeled. The modeling may produce an overall topic, or, in the alternative, different parts of the speech may be segregated and separately modeled. The overall text may be topic modeled to generate overall topics, or in the alternative, different parts of speech may be segregated and separated topic modeled. Once the topic models are formed, each or some of them may be labeled and visualized in a map, for example, or by any other visualization means considered appropriate. In one example, the extracted topics are mapped to specific keywords or phrases. Next, the text in the database may be processed stylometrically, i.e., a number of sentences may be ascertained, or lengths of individual paragraphs, as well as a length of an entire document may be determined. Any of these criteria, alone or in combination, can be incorporated in the comps generation. Stylometric analysis is not limited to these features, however, and includes other such as the tone, pacing, unique authorial attributes, and other features deemed suitable in assessing the “style” of a piece of scripted media.

The comps creation methodology may include collecting n-grams for each title to include words, letters, syllables, phonemes, etc., and readability indicators may be calculated. The analyzed text may be processed to determine to plot of the scripted media, and the plots may be organized and categorized into plot archetypes to be compared with popular plot types or plots of popular content, or any other subset of content, for example. Moreover, named entities identified from the processed text may be recognized as character names, or can be used to identify geographic or topographic locations, or can be ontologically categorized.

A set of hand-crafted textual features was determined using industry knowledge and data science research. Upon extracting those proprietary features from the text using machine learning algorithms, the performance analytics system component may use dimensionality reduction methods such as principal component analysis and factor analysis to identify features that are relevant to the content of a book, movie, TV, webseries, for example or other piece of scripted media. Next, the system may be programmed to run similarity computations, including cosine similarity and other proprietary algorithms, and detect books with similar content. The comparability of titles can be assessed based on numerous criteria, some of them being setting, character, style, topics, sentiment, etc. In the alternative, the system can return comps, i.e., similar titles, based on the totality of relationship between titles, i.e., based on the “overall” comparability.

For any computation of comparable titles, there may be a “seed” title that can return results from a “recall set.” One example of the system limits and restricts the recall set according to the needs of the publishers. On one hand, the publishers may select the content of their books to be compared to bestsellers, or, on the other hand, the comparison may be performed in reference to other titles within a customized title selection made by the publishers.

Once the comps are created, they can be generated for a prospective manuscript to determine marketability and sales/market niche. The comps can enhance marketing and sales efforts by listing comp titles that are more relevant to the content of the title. Such listings may be forwarded to a publisher's marketing team, or to a content distributor, e.g., iBooks, Kindle, etc. The comps may further enrich metadata. Namely, the system may be programmed to add the comps to a “Description” field of a book to increase its discoverability in search engine optimization. For example, the bottom of a description field might contain the phrase: “For readers who loved {title} by {author} or {title} by {author}.”

In one embodiment, the performance analytics system component may use an S3 bucket that system users can upload movie scripts into via a specified File Transfer Protocol (FTP). The system may automatically pull down files (PDF, text file, HTML, or other document format deemed appropriate), convert the document to a text file, and store them in the database, which may be a relational, non-relational, or other database type deemed appropriate. The files that do not have easily extractable text formats may be processed using OCR techniques, and the text may be migrated from the customer facing storage system, which may be an S3 bucket to an internal logical unit of storage.

If a client provides labels for movie script files, the performance analytics system component may store those labels in a proprietary database. The label storage feature may be used for training a custom algorithm and calculating proprietary scores, for example. For text-based PDFs, text files, the system may be programmed to send the scripts through real-time collaborative screenwriting software such as WriterDuet, for example. The software may automatically reformat the raw scripted content into a standardized script format.

For non-text formatted scripts, the system may be programmed to run optical character recognition software to convert to text format, then send through WriterDuet for further cleanup. The script ingestion process may include developing a set of tools or rules for script cleanup to ensure that scripts are read in consistent formats, and creating an algorithm applied to split scripts into text based, non-text based, etc., and those requiring further cleanup. Next, a manual cleanup of scripts may be performed after the automated processing. WriterDuet may further create a cleaned-up text file, and a proprietary .csv file that parses scripts into action, dialog, shots, and other features. The scripts may be mapped to an entry in an online movie database such as IMDb, or assigned a proprietary identification number.

The ingested script may be analyzed and processed by reading in .csv files from the WriterDuet output that contains dialog, action, shots, and other script structure data. Some of the basic script feature extraction steps may include counting scenes, action turns, dialog turns, locations (interior or exterior, during daytime or nighttime, etc.). The dialog may be attributed to the associated characters, and analyzed by character to be broken down by various demographic details when cross-referenced with IMDb data on actors and characters.

The performance analytics system component may run machine learning tools on parsed script data by sentiment tagging using a proprietary dictionary. The dictionary may be built on pre-trained neural networks from a variety of AI research companies, such as OpenAI. The neural network may be a third party pre-trained neural network, trained on online reviews, for example.

The system may map sentiment over the course of an entire text, and perform a sentiment analysis subsequently. A Proselint library may be used to check for grammatical errors. Proprietary algorithms may be used to detect the point of view of the content (e.g., first person, third person).

The topics and themes may be extracted from the content of the documents and modeled using topic modeling. The modeling may produce an overall topic, or, in the alternative, different parts of the speech may be segregated and separately modeled using topic modeling. Once the topic models are formed, each or some of them may be labeled and visualized in a map, for example, or by any other visualization means considered appropriate. In one example, the extracted topics are mapped to specific keywords or phrases. The text in the database may be processed stylometrically, i.e., a number of sentences may be ascertained, or lengths of individual paragraphs, as well as a length of an entire document may be determined. Stylometric analysis is not limited to these features, however, and includes other such as the tone, pacing, unique authorial attributes, and other features deemed suitable in assessing the “style” of a piece of scripted media.

Further, n-grams may be collected for each title to include words, letters, syllables, phonemes, etc., and readability indicators may be calculated. Some of the indicators may be reading scores, reading ease, Fleish-Kincaid, Coleman-Liau, or any other indices deemed suitable.

The analyzed text may be processed into plots to extract the plot of its narrative, and the plots may be organized and categorized into base or “archetypical” plot types. Moreover, named entities identified from the processed text may be recognized for their character names, or can be correlated with a geographic location, or can be ontologically categorized. A variety of natural language tools may be applied for the recognition and matching, one of such tools being the Watson NLP. Depending on the individual characteristics of an application, the application may be modularized or containerized by using a virtual machine, such as Docker virtual machine, for example.

The system may additionally conduct a metadata collection to be used for training. Metadata related to the scripted media content may be collected from an online movie (or other scripted media) database, such as IMDb, or other appropriate sites. Associated data may include character names, cast, awards, directors, producers, writers, genre, box office figures, descriptions, ratings, etc. International and domestic (e.g., U.S.) box office figures may be collected from other box office sites such as BoxOfficeMojo, for example. Awards may be manually parsed into categories “good” or “bad” in order to use awards as training metric. The system may be programmed to further gather metadata for persons associated with the movie, including the cast the crew.

The system may extract and store features from the ingested content on a per-movie or per-character in a movie basis in any database type deemed appropriate. Those features may include topic, setting, character type, etc. In terms of feature selection, a machine learning algorithm may be applied to detect which features are important to either box office prediction, or awards prediction. A dimensionality reduction method, such as principal component analysis or factor analysis, may be applied to an entire feature set. The selected features can be either displayed “as is” for a movie, or used as training parameters for predictive modeling, for example.

The performance analytics system component may create script reports and dashboards. Each ingested script may return a report containing the relevant script features, including Motion Picture Association of America (MPAA) rating features, overall features, proprietary scores for each script, sentiment/emotion/tone of the content, analysis of the characters, and/or structure, style, and plot analysis.

The MPAA rating features may include cursing, harsh language, vulgarity scores, sexuality score, graphic violence score, etc. The overall features may comprise the number of scenes, percent of action versus dialog, an average dialog per scene, the number of main characters, percent of dialog by gender, and the average number of characters per scene, the overall sentiment/emotion/tone, and dominant emotions for the script, as well as keywords for any particular movie, for example.

The proprietary scores for each script may contain a box office prediction score, such as profit, return on investment, budget, gross, or any transformation of these outcome variables (logarithmic, inverse, etc.), an awards prediction score, e.g., number of awards, types of awards, nominations, etc., and a custom algorithm prediction score. System users may provide tagged scripts from, (tagged as “Good”, “Bad”, “Best”, etc.), and a model may be trained to predict how a new script would be classified based on their personalized training data by assigning a score for how well a script matches parameters of a given user.

Examples of sentiment/emotion/tone may be overall emotional palette, or emotional change over script. Moreover, a character analysis may address number of characters (main or total), character names, maximum number of characters per scene, distribution of characters per scene. The character analysis may further entail identifying male as opposed to female characters, including the corresponding dialogs. For each of the main characters with a certain threshold of lines, data regarding gender, percent of dialog, percent of scenes present, emotional palette, and personality profile may be provided.

The structure, style, and plot analysis may process number of scenes and distribution of interior/exterior and day/night scenes, locations of scenes, dialog and action plot over script, plot archetype, sentiment plot, or ending type.

Feature reports can provide comparisons to other movies, or provide aggregate scores. A dashboard and corresponding user experience/user interface may be created accordingly to present results and comparisons. Feature reports regarding user experience and user interface can also be compared to other movies or to aggregate scores, and a dashboard may be created accordingly. For example, the system allows a user to compare the features of two titles side by side, or to compare the features of one movie to the aggregate features of commercial successes, or to compare features of one movie to subsets of other movies (e.g., top comedies, top drama, cult classics, etc.).

The reports may be used during the pre-acquisition stage or subsequent to the production. In the pre-acquisition, a studio may run a script through the system algorithms to get a script feature report to help with the approval process. The system allows for comparison of a corpus of scripts to each other or to big commercial successes, for example. Script features may be used to recommend actors and actresses or directors in light of a selected script's features. The reports created by the performance analytics system may be used to assist in budget recommendations.

Regarding post-production, the feature reports could be integrated into a recommendation engine for a content distributor, such as Amazon, Netflix, iTunes, etc. The feature reports may also be used to create collections of movies in support of marketing and sales activities for content distributors.

One of the major challenges in the publishing/entertainment industries is the maintenance, generation, and validation of the metadata for their content. The metadata may be used to increase product discoverability, and search result engine optimization (SEO). One use of the technology is generating data algorithmically, where the data derived from the actual text of a script or manuscript can be ingested into metadata feeds. This capability assists metadata managers within publishing houses and production studios.

The system can either generate new metadata or validate existing metadata for scripted media. The system then formats the metadata per appropriate industry standards to be used in content/metadata management systems. The metadata information includes but is not limited to the category of the content, its genre, description verbiage, cover image, or other fields included in a metadata listing for the given content.

To generate enriched metadata, the performance analytics system component may use the same ingestion, processing, and machine learning tools as in the prior description of generating keywords from scripted media. On the other hand, the system may use the same ingestion, processing, and machine learning tools as described in the description of the analysis and coverage reports for scripted media above.

In addition to all the features analyzed for keywords and reports, enriched metadata may include: predicted genres/categories, related titles or works of art, optimized descriptions or “blurbs” for a piece of work, suggested subtitles to increase search optimization or any corrections to existing metadata that may or may not have been filled in manually by a human.

Enriched metadata can be provided to customers in a variety of formats. One of the formats may be a spreadsheet containing all relevant fields of metadata selected by the customer, for example. Another exemplary format may be a proprietary API, where publishers or studios can connect metadata directly into their metadata feeds to be sent to distributors. For publishers, the proprietary API may be in ONIX format and for libraries, another client market, metadata may be provided in MARC records format. Moreover, for studios, metadata may be formatted as appropriate for movies, television, web series, or any other requested format.

In terms of uses of metadata products, the metadata may be updated automatically to save editor's time from the outset, or quarterly based on the current media market and new trends. In addition, metadata may be fed directly into retail sites (such as Amazon) metadata feeds to aid product marketing.

In one embodiment, a “manuscript report” is a synopsis of a book title based on a comparison with thousands of previously published titles. The report may include features of the text, including characters and character networks, sentiment, setting, style, or any other factors deemed suitable. The report may further include scores to predict the prospective marketability, sales earnings, or award potential of a title, either before acquisition of the title, or after acquisition. The manuscript report also allows for comparisons between books within a corpus.

Reports may include any or all features of a portion of in the prior description of generating keywords from scripted media mentioned above, in addition to optional comparable titles described above, and they may include same ingestion, processing, and machine learning tools as in the description of generating keywords from scripted media. Further, reports may be broken down into the following sections: overall predictive scores, character analysis, setting analysis, style analysis, topic analysis, theme analysis, plot analysis, sentiment analysis/emotional arc, audience analysis/predicted audience, and comps. In terms of report format, reports may be delivered as PDFs on a per-title basis, or in an interactive dashboard provided in a proprietary User Interface with specified User Experience (UI/UX). A dashboard may be used to display each of the sections for a single title. The dashboard allows a user to display comparisons between multiple titles, or an entire corpus of texts.

Publishing reports can supplement or replace the individual comps product. Use cases for publishing reports may include any or all of those noted under “comps.” Publisher may want reports for their entire slush pile, and then to have the slush pile returned after being ranked for possible success. In addition, use cases allow publishers to make more informed and faster decisions on their titles that they will either acquire or market.

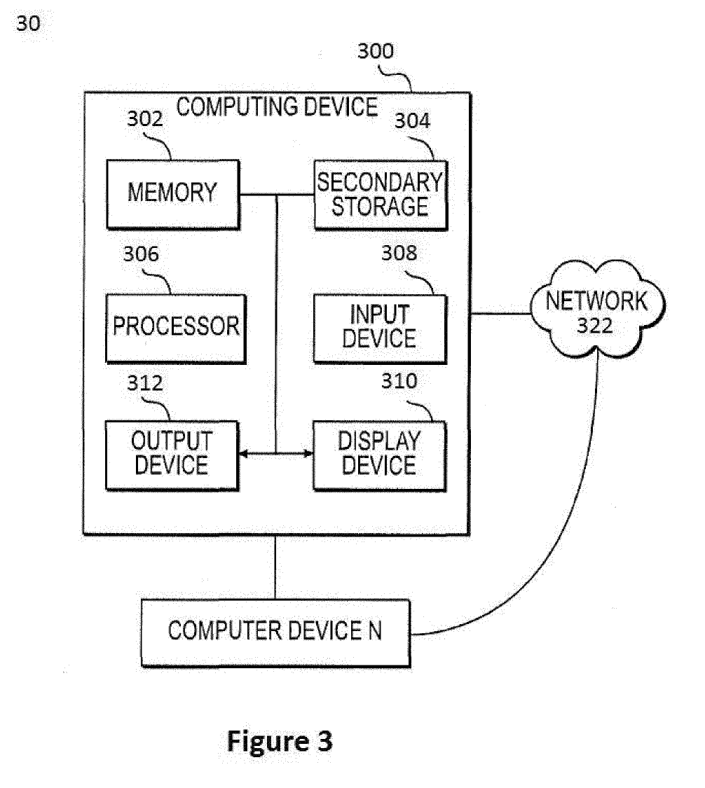

The scripted content data entry, management and processing may be performed on a computing device as shown in FIG. 3. A block diagram of FIG. 3 illustrates a system 30 that includes one or more networked computing devices or systems 300. System 30 may include a server computing device 300 to make the connections and/or run the processing on multiple clients or otherwise networked computing devices 300. Computing system 300, including client-servers combining multiple computer systems, or other computer systems similarly configured, may include and execute one or more subsystem components to perform functions described herein, including steps of methods and processes described above.

Computer system 300 may connect with network 322, e.g., Internet, or other network, to receive inquires, obtain data, and transmit information and incentives as described above. Computer system 300 typically includes a memory 302, a secondary storage device 304, and a processor 306. Computer system 300 may also include a plurality of processors 306 and be configured as a plurality of, e.g., bladed servers, or other known server configurations. Computer system 300 may also include an input device 308, a display device 310, and an output device 312. Memory 302 may include RAM or similar types of memory, and it may store one or more applications for execution by processor 306.

Secondary storage device 304 may include a hard disk drive, CD-ROM drive, or other types of non-volatile data storage. Processor 306 executes the application(s), such as subsystem components, which are stored in memory 302 or secondary storage 304 or received from the Internet or other network 322. The processing by processor 306 may be implemented in software, such as software modules, for execution by computers or other machines. These applications preferably include instructions executable to perform the system and subsystem component (or application) functions and methods described above and illustrated in the herein. The applications preferably provide graphical user interfaces (GUIs) through which users may view and interact with subsystem components (or application in a mobile device).

Computer system 300 may store one or more database structures in secondary storage 304, for example, for storing and maintaining databases and other information necessary to perform the above-described methods. Alternatively, such databases may be in storage devices separate from subsystem components. Also, as noted, processor 306 may execute one or more software applications in order to provide the functions described in this specification, specifically to execute and perform the steps and functions in the methods described above. Such methods and the processing may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the system (or application).

Input device 308 may include any device for entering information into computer system 300, such as a touch-screen, keyboard, mouse, cursor-control device, touch-screen, microphone, digital camera, video recorder or camcorder. The input device 308 may be used to enter information into GUIs during performance of the methods described above. Display device 310 may include any type of device for presenting visual information such as, for example, a computer monitor or flat-screen display (or mobile device screen). The display device 310 may display the GUIs and/or output from sub-system components (or application). Output device 312 may include any type of device for presenting a hard copy of information, such as a printer, and other types of output devices include speakers or any device for providing information in audio form.

Examples of computer system 300 include dedicated server computers, such as bladed servers, personal computers, laptop computers, notebook computers, palm top computers, network computers, smart phones, mobile devices, or any processor-controlled device capable of executing a web browser or other type of application for interacting with the system.

Although only one computer system 300 is shown in detail, system and method embodiments described herein may use multiple computer system or servers as necessary or desired to support the users and may also use back-up or redundant servers to prevent network downtime in the event of a failure of a particular server. In addition, although computer system 300 is depicted with various components, one skilled in the art will appreciate that the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, or CD-ROM; or other forms of RAM or ROM. The computer-readable media may include instructions for controlling a computer system, computer 300, to perform a particular method, such as methods described above.

FIG. 4 shows an example flow chart of a similarity comparison engine of the present application. A selected piece of content, e.g., Content A, is initially pre-preprocessed in preparation for content feature extraction. In one embodiment, the scripted content of Content A is pre-processed, and in another embodiment, pre-processing is performed on Content A metadata. In yet another embodiment, both the scripted content and the metadata of Content A are pre-processed in order to facilitate the feature extraction. In addition, the performance analytics system component may pre-process screenplay, books, video games, or any other scripted content of interest to a user or a partner.

In one embodiment, once the content has been pre-processed, it is input into a feature extractor, where the extraction of the various sets of features of the content is performed, and when the selected features of the content may be organized to be compared with a database of scripted content features. The database of the scripted content features may be created manually, in code, or by the combination of the two, by gathering and organizing a large amount of data on the existing available content, including the corresponding scores and performance metrics relevant to the existing scripted content.

Feature engineering and feature extraction steps may vary depending of the type of data. Further processing of the data may include transformations. In order to prepare the extracted feature for similarity computations, any of the following steps on the features or feature sets may be performed: normalization, standardization, scaling, binning/bucketing, encoding of categorical variables, or any other transformations deemed appropriate, including any combination of the identified steps.

A set of hand-crafted textual features may be determined using industry knowledge and data science research. Upon extracting those proprietary features from the text using machine learning algorithms, the performance analytics system component may use dimensionality reduction methods such as principal component analysis and factor analysis to identify features that are relevant to the content of a book, film, TV, webseries, or any other piece of scripted media.

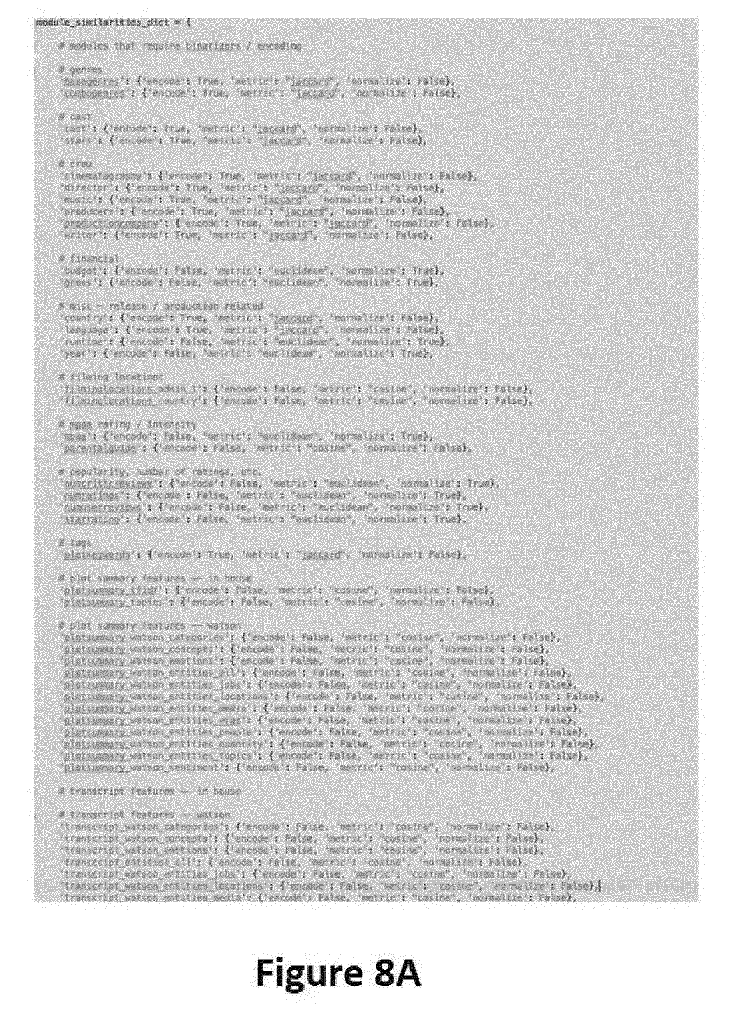

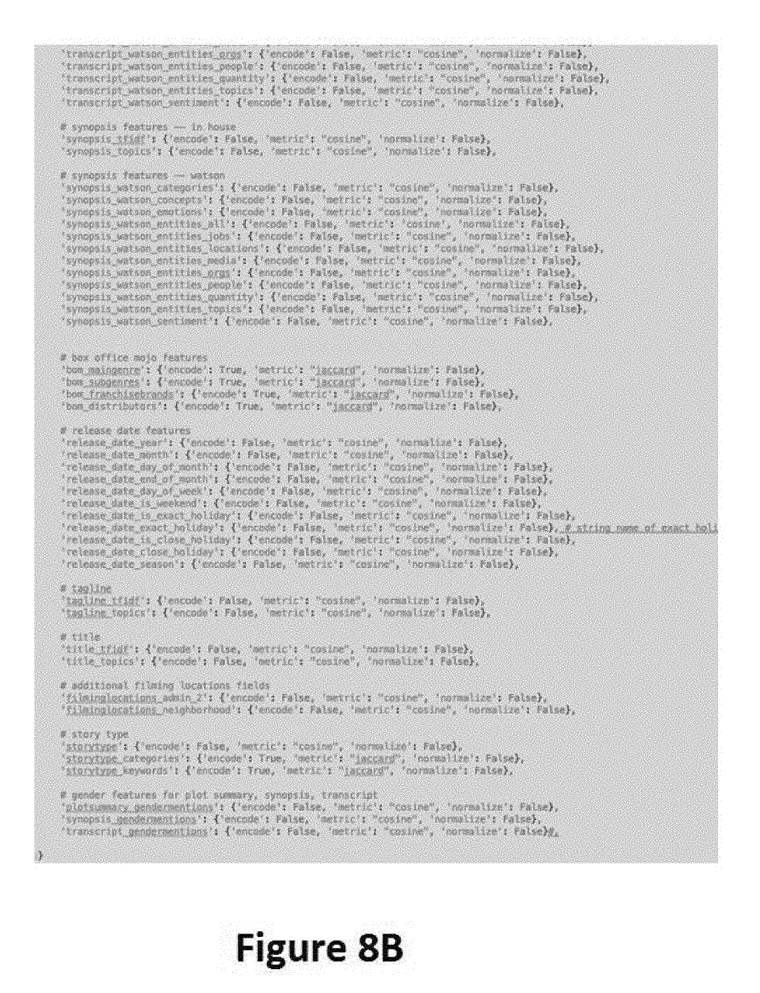

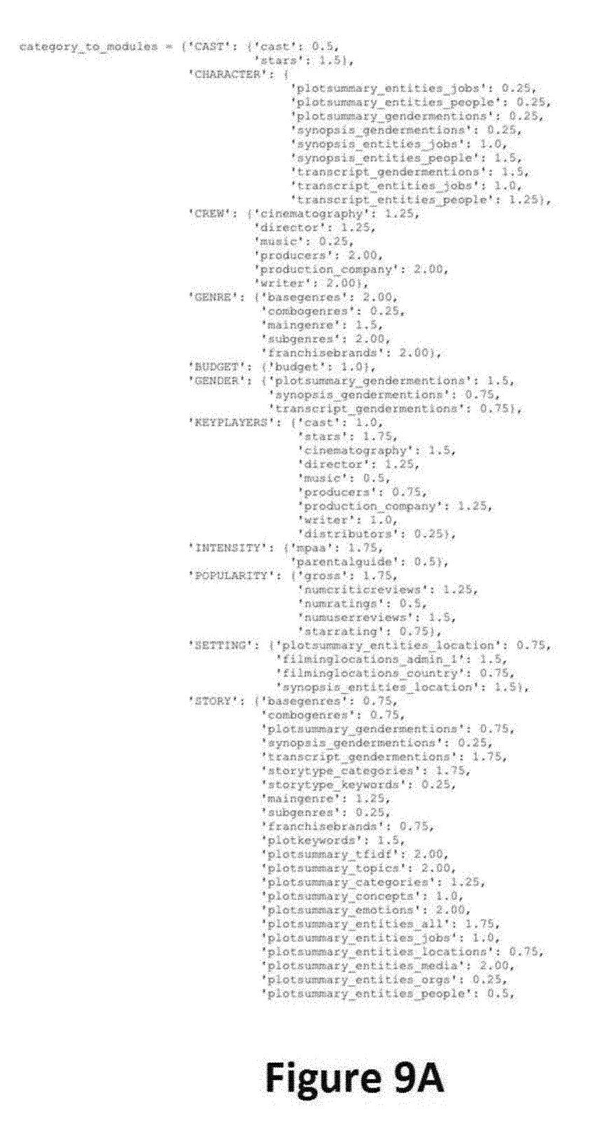

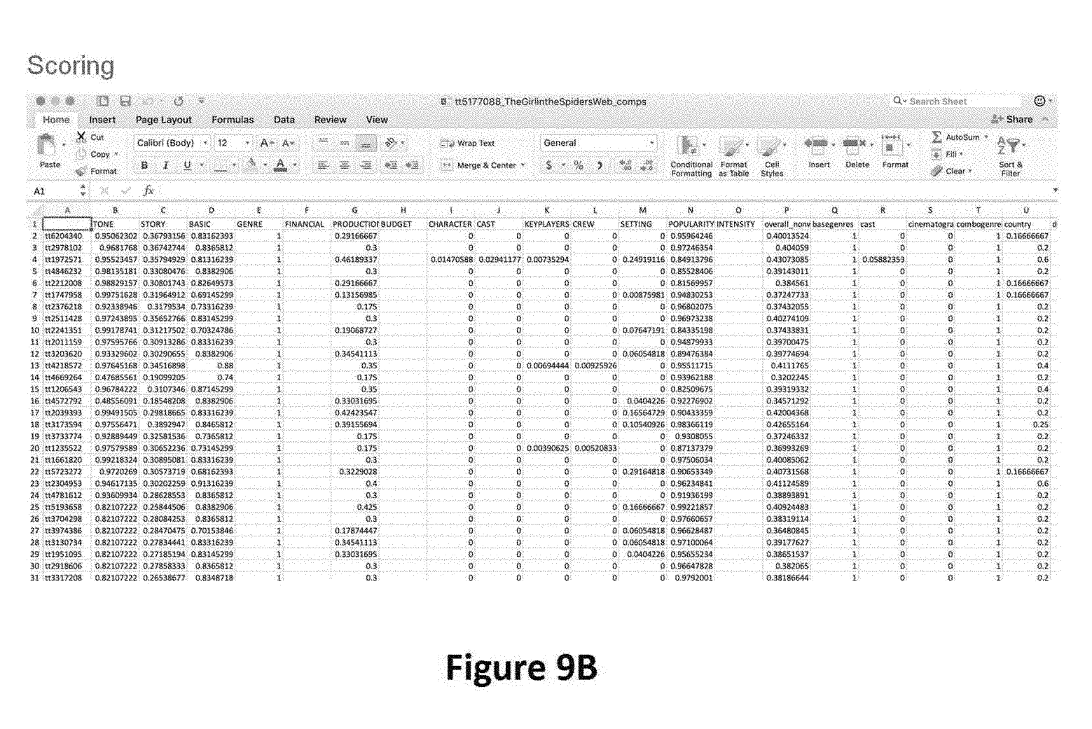

Further as shown in FIG. 4, once Content A features have been pre-processed and extracted, they may be compared with the database of features from other content in a similarity calculator, as will be described in detail below, in regard to FIGS. 8A-B and FIGS. 9A-B. In one embodiment, results of the similarity computation include scores for each compared and processed feature. In another embodiment, results of the similarity computation include scores by all of the compared and processed features. In yet another embodiment, results of the similarity computation include scores for selected feature groups.

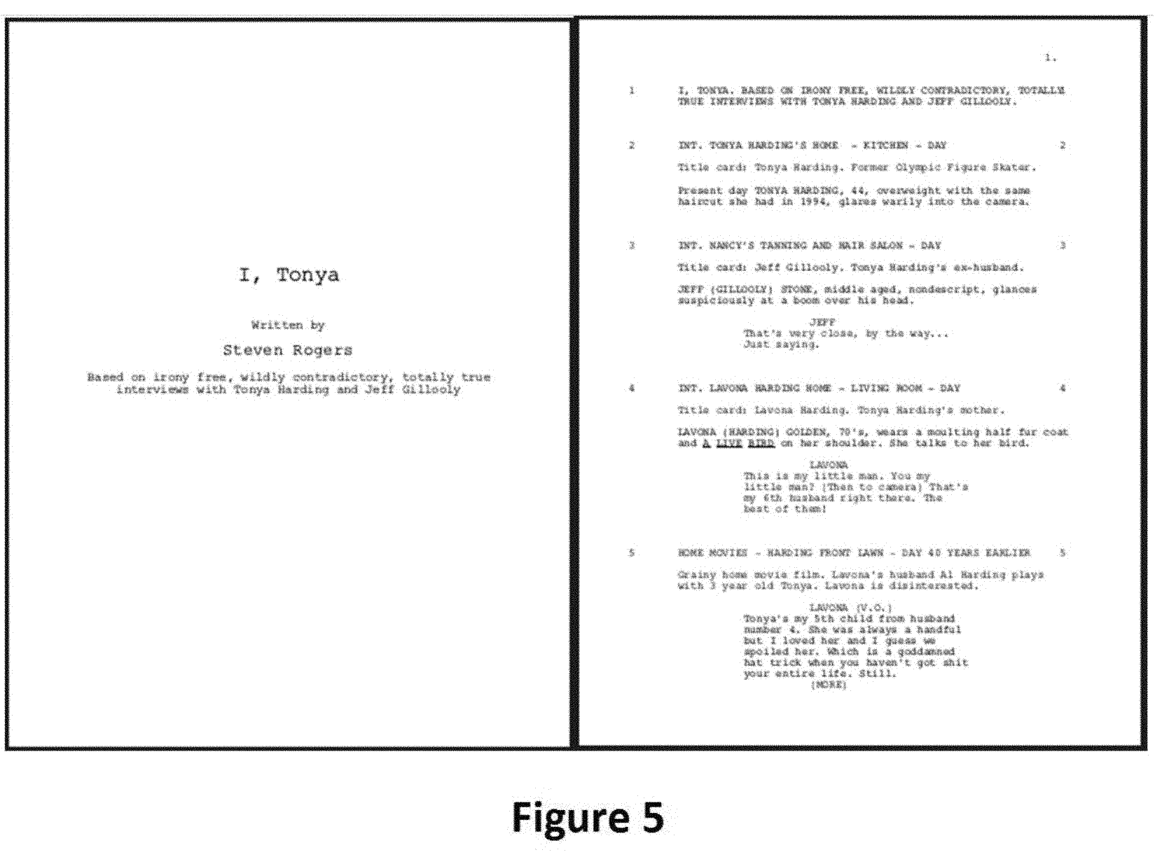

Turning specifically to pre-processing, this step may involve a screenplay processing ingestion pipeline in order to convert a screenplay from a .pdf or text format into a structured, consistent format. In addition, data pre-processing may be performed on books as well as screenplays. FIG. 5 shows an example of a screenplay file (excerpt from the film “I, Tonya”) used as input for data pre-processing. In one embodiment, script ingestion technology automatically converts the .pdf screenplay to text format. Next, the resulting text file may be processed to automatically classify each section of the screenplay into subsections, such as, for example, scene header, action, character name, parenthetical, dialog, transition, and shot. Additionally, the performance analytics system component may automatically identify gender, age, and other features of each character.

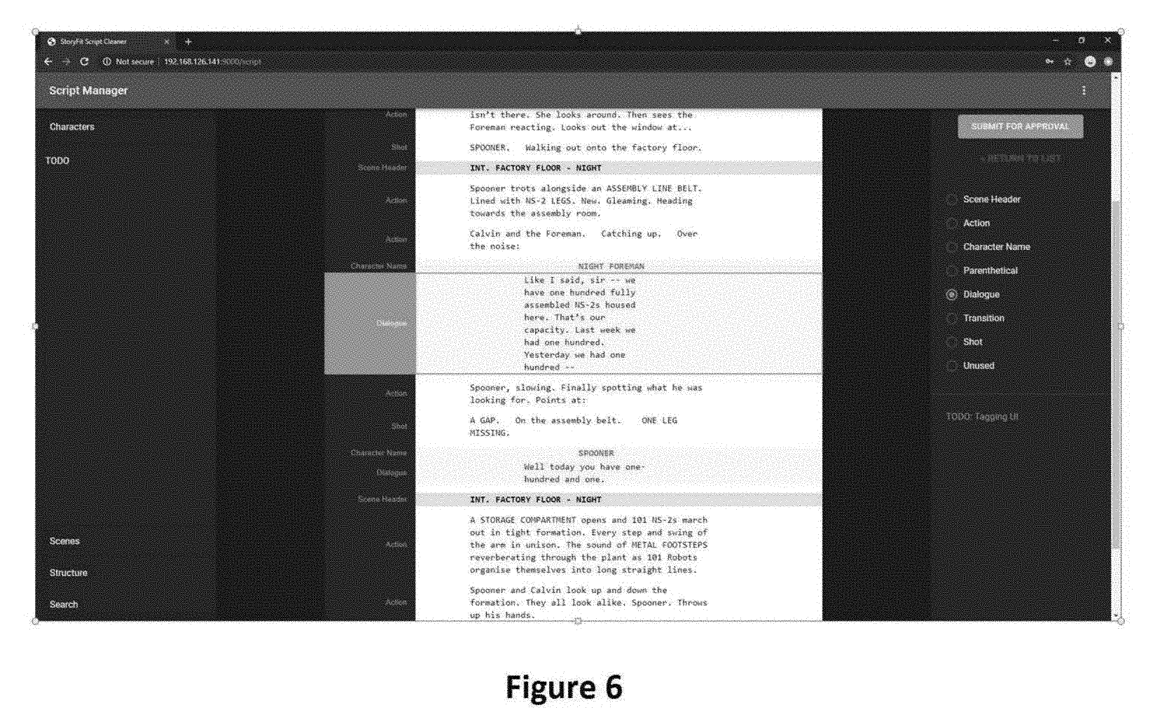

In one embodiment, the pre-processing includes automatically computing metrics about how much dialog is spoken by each character, the complexity of the dialog, and other stylistic features. In another embodiment, data pre-processing includes manual (human) verification, as shown in FIG. 6. For example, a user interface (UI) may be provided to allow human evaluators to correct any errors in the automatic screenplay ingestion. The error correction may include re-classifying sections of the script into the correct “type,” and/or identifying any errors in the gender identification algorithms. Some of the scripted content types may include scene header, action, character name, parenthetical, dialogue, transition, shot, etc.

The UI component allows the performance analytics system component to assign reformatting tasks to screenplay formatters in order to check the formatting, and submit their tasks for approval. Subsequently, the system may automatically save the pre-processed screenplay in the database in a structured format.

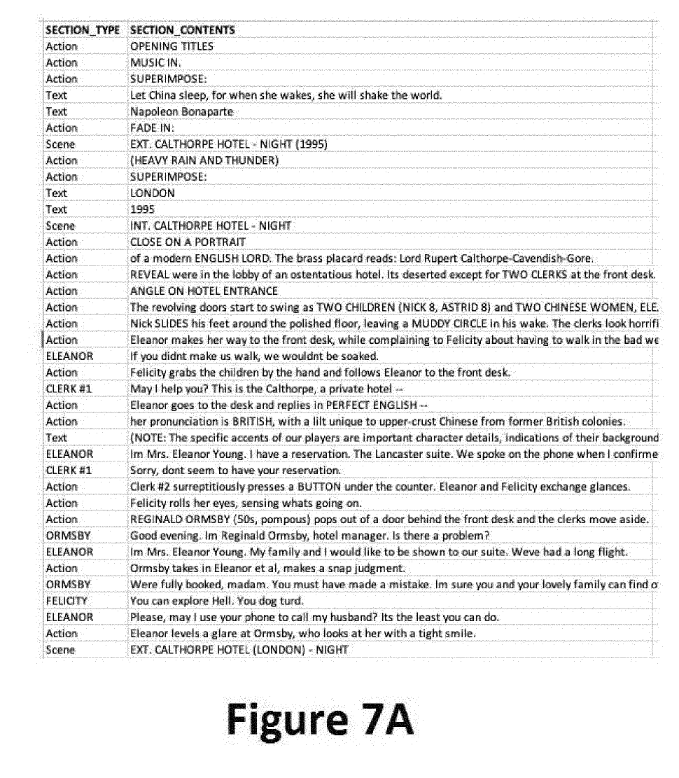

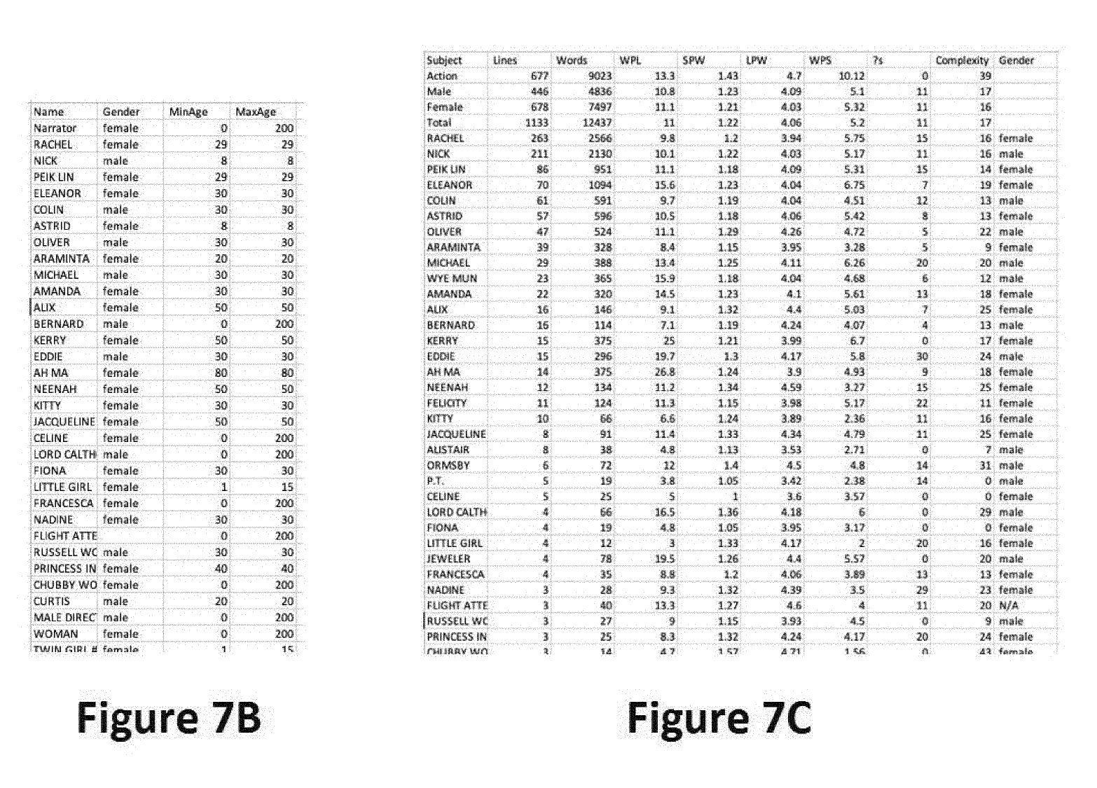

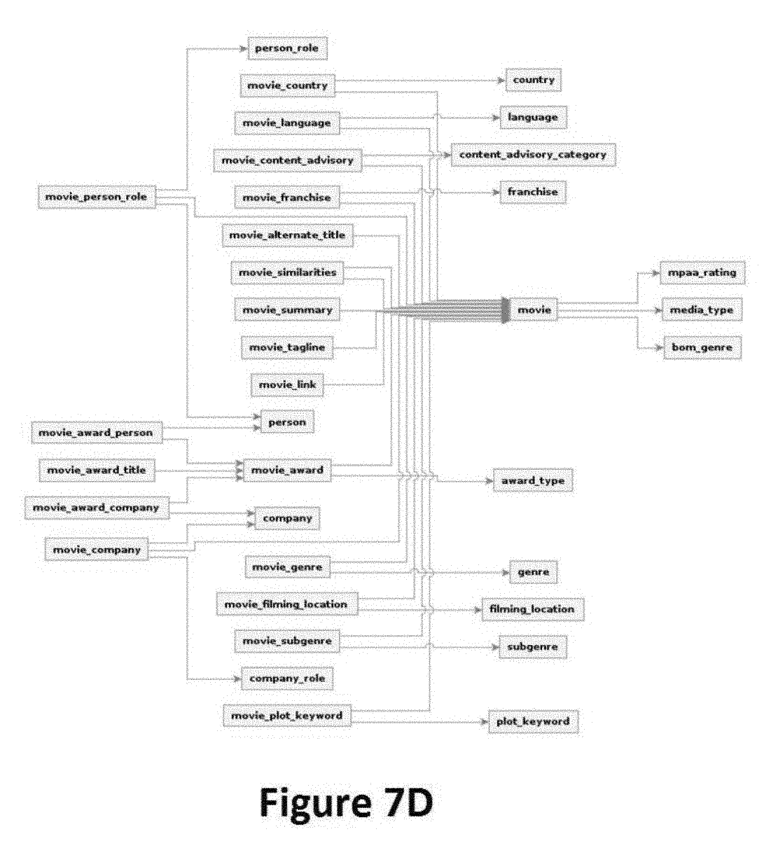

FIG. 7A shows an example of a screenplay pre-processed in a structured format. One embodiment of a structured format is a .csv dataset, where each section or line of the screenplay is tagged into components. The pre-processed information divided into the components may be categorized into section types, such as “Action,” “Text,” “Scene,” “Dialogue” lines uttered by individual characters (e.g., Eleanor, clerk 1, Felicity), etc. Each section type may be correlated to its content. As shown in FIG. 7A, “Action” may be any content that describes acted out portions of a plot, for example, by characters or by a film director. Moreover, “Text,” may be any textual portion of the script, including descriptive notes. “Scene” may be any environment where the action occurs, such as a setting or any other contextual information.

In yet another embodiment, the character features and stylistic metrics are computed at the pre-processing stage. For example, in FIG. 7B, gender, age, and other character data are prepared for extraction. Additional statistics and metrics computed based on a character's dialog during the screenplay pre-processing step can be organized into a structured format, as shown in FIG. 7C.

FIG. 7D illustrates an example of data collection and storage operation flowchart for screenplay content. In one example, the features database includes the stored features organized in sets of features. The metadata ingestion and pre-processing may include arranging features into feature sets in order to optimize the computation and the results, e.g., feature scores, in light of the arrangement of the features database. The features in the database may be interpretable, e.g., features that include counting the number of characters, or non-interpretable, e.g., features derived from neural networks.

In one embodiment, there are approximately 60,000 features in the database organized in approximately 200 feature sets. In another embodiment, the number of features ranges between 50,000 and 70,000 features, and in yet another embodiment, the number of features ranges between 20,000 and 100,000 features. In one example, the number of feature sets ranges between 100 and 300 sets, and in yet another embodiment, the number of feature sets ranges between 50 and 500 sets. The number of features in each set may range from 1-3000 features/set, or from 10-1000 features/set, or from 50-500 features/set, in order to optimize performance of similarity computations between different pieces of content.

In one example, the list of features in the database that is divided into feature sets is further organized to group multiple feature sets to belong to a specific feature type. In another example, each individual feature within a set belongs to the same feature type as the set, itself. The feature sets in the database may be empirically created and arranged into sequences or collections to correspond to targeted feature types.

Turning back to the similarity calculator shown in FIG. 4, the performance analytics system component may use a different type of similarity computation steps as a function of a feature or a feature set engineered or extracted. That is to say, depending on the feature being compared, a different type of similarity computation may be used. The performance analytics system component may generate a set of comps for a seed title, where seed titles may be compared to other titles, overall or in a given dataset, such as a dataset of all books from a certain publisher, for example.

The system may be programmed to run similarity computations, including cosine similarity, Jaccard similarity, Euclidean distance/similarity, or other custom similarity metrics as required, depending on the type of data use, and detect content with similar features. The comparability of titles can be assessed based on numerous criteria, some of them being setting, character, style, topics, sentiment, etc. In the alternative, the system can return comps, i.e., similar titles, based on the totality of relationship between titles, i.e., based on the “overall” comparability.

FIGS. 8A-B show examples of the various similarity calculations that may be performed on different sets of features comparing content features and database features for predetermined content types and performance metrics. The desired scores resulting from the computations of the similarity calculator may include a genre similarity, screenplay financial similarity, filming location similarity, MPAA rating similarity, likely popularity similarity, synopsis features similarity, box office performance similarity, etc.

FIG. 9A shows an example of scores computed by similarity calculators for each unique category feature, such as character, crew, genre, budget, gender, key players, intensity, popularity, setting, story, etc. Similarity of raw features may be computed individually to compute individual scores (“plotsummary_entities_jobs”: 0.25, “plotsummary_entities_people”: 0.25, etc.). Subsequently, the individual scores may be aggregated as weighted combinations to compute a score for the entire category (“CHARACTER”), as shown in FIG. 9A.

FIG. 9B shows an example of scores computed by similarity calculators for each unique feature of the film “The Girl in the Spider's Web” with respect to its comps, listed in Column A of the presented spreadsheet. In this example, for every film paired up with the targeted film, similarities are computed along dozens of modules, such as setting, character, plotkeywords, etc. These individual modules may be combined into custom macro-scores, and the mapping between categories and modules below may be performed to arrive at the “category similarities”:

### “CAST”: 0.0058823529,

### “CHARACTER”: 0.3259153663,

### “CREW”: 0,

### “GENRE”: 0.2833333333,

### “BUDGET”: 0.8860759494

In one embodiment of the performance analytics component, predictive modeling techniques are used based on features of the scripted content. The predictive models may be trained on scripted content, or metadata, or the combination of the scripted content and the metadata. In one example, for each predictive model, the performance analytics system component may have different accuracy, a different set of features that the model is used for, and/or a different set of data that the model is used for. In another example, the performance analytics system component uses different types of predictive models.

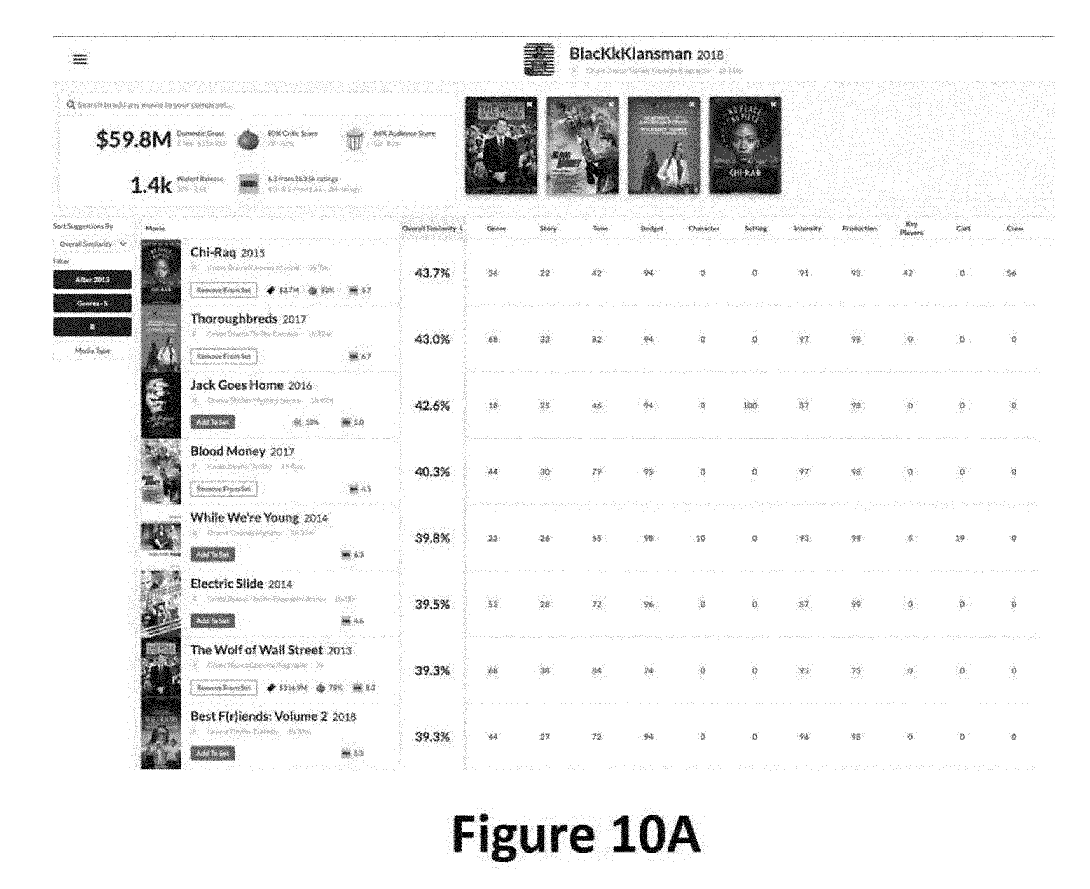

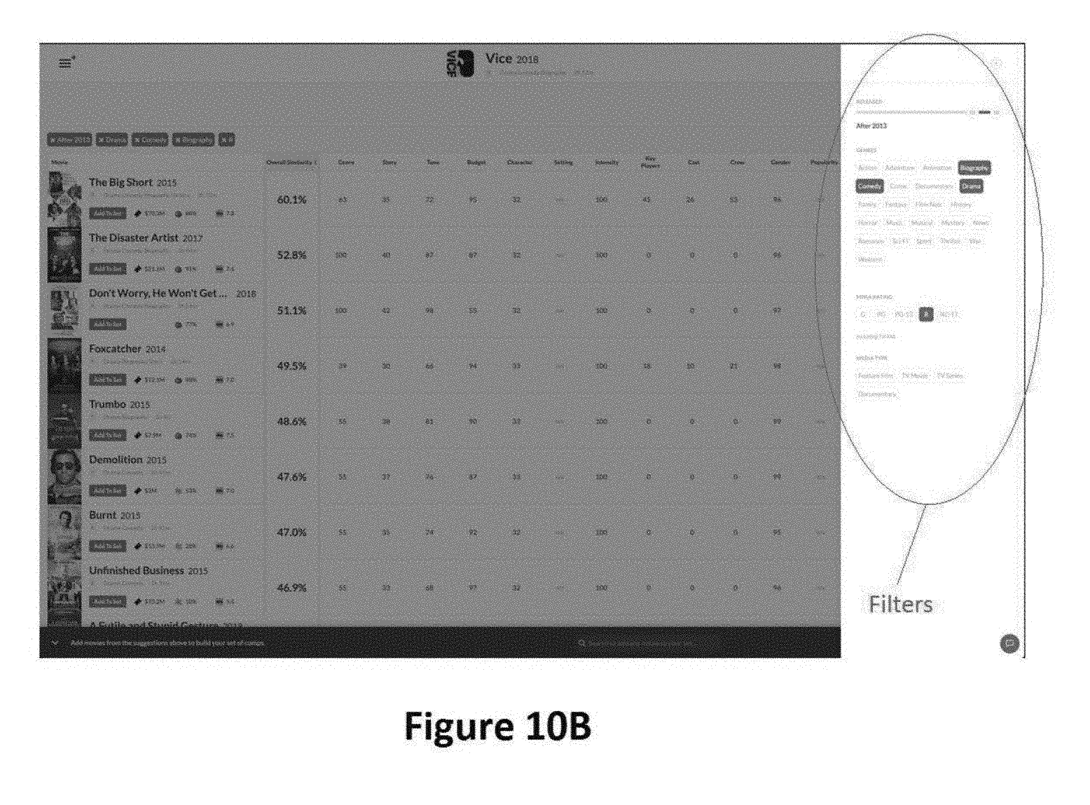

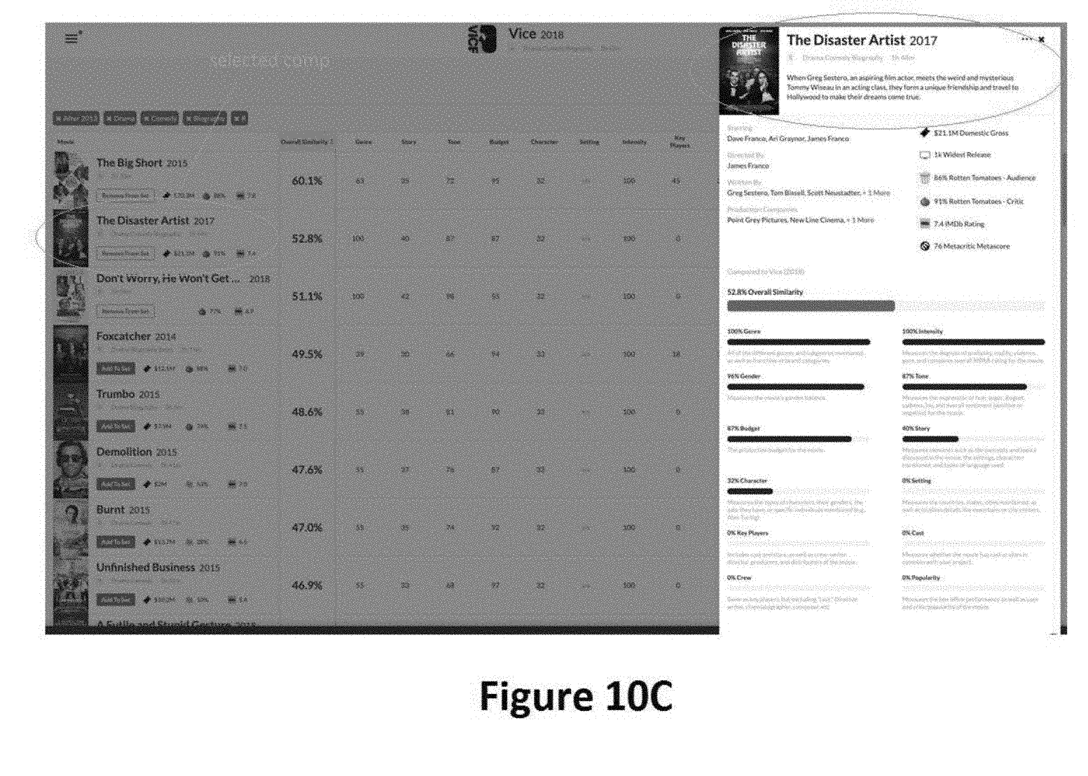

One of the practical applications of the performance analytics system is a dashboard that provides visualization of comps for particular scripted content, and/or details and metadata about the particular scripted content as shown in FIG. 10A. In one embodiment, a selected screenplay is processed in a comparison engine and the similarity scores/results are visually presented. The dashboard may include a list of comps that may be filtered or unfiltered. A number of the comps included on the list may be curated by a user or a partner of the performance analytics system in order to aggregate performance scores. FIG. 10A shows an example of the comps dashboard that allows a user or a partner of the performance analytics system to concentrate on selected comps from the full list of comps in order to analyze the selected comps in detail and/or average their scores.

One example of the comps dashboard may show overall similarity score between the selected screenplay and each of the comps. In another embodiment, the comps dashboard may show similarity scores between the selected screenplay and each of the comps for each of the desired features.

FIG. 10B shows an example of the comps dashboard that allows a user or a partner of the performance analytics system to filter the comps based on a variety of criteria. For example, the comps dashboard may be interactive in order to enable a user or a partner of the performance analytics system to remove certain comps from the list and emphasize on others, based on a release date range, genre, MPAA rating, media type, etc. FIG. 10C shows an example of the comps dashboard that allows a user or a partner of the performance analytics system to concentrate on one particular comp from the list of comps in order to analyze the selected comp in detail.

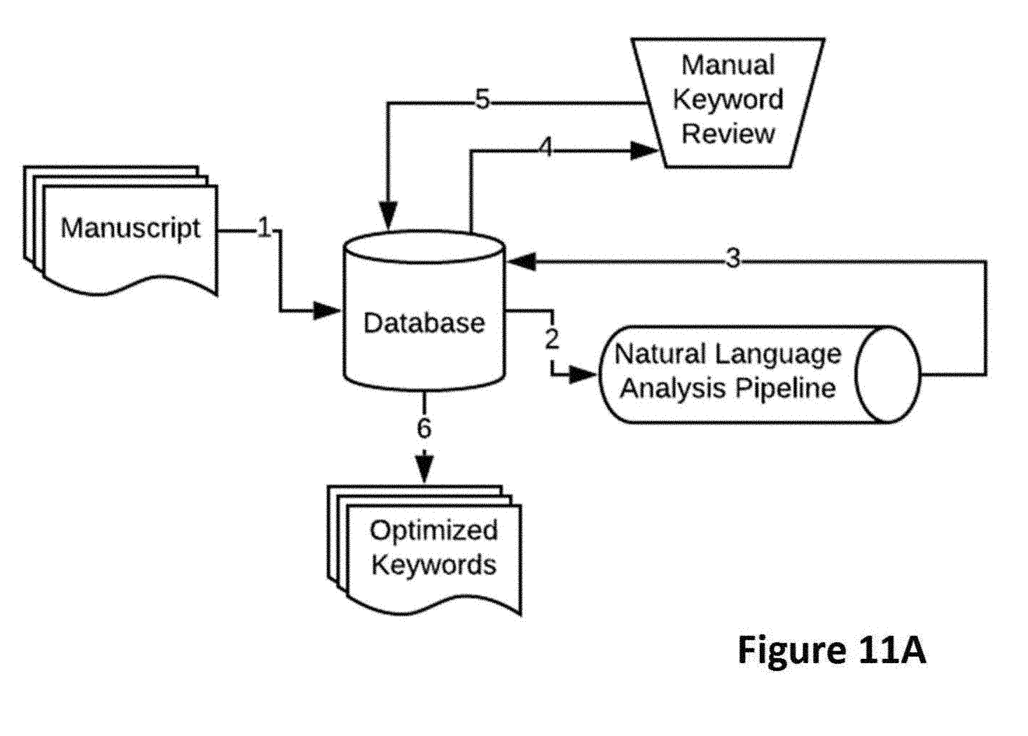

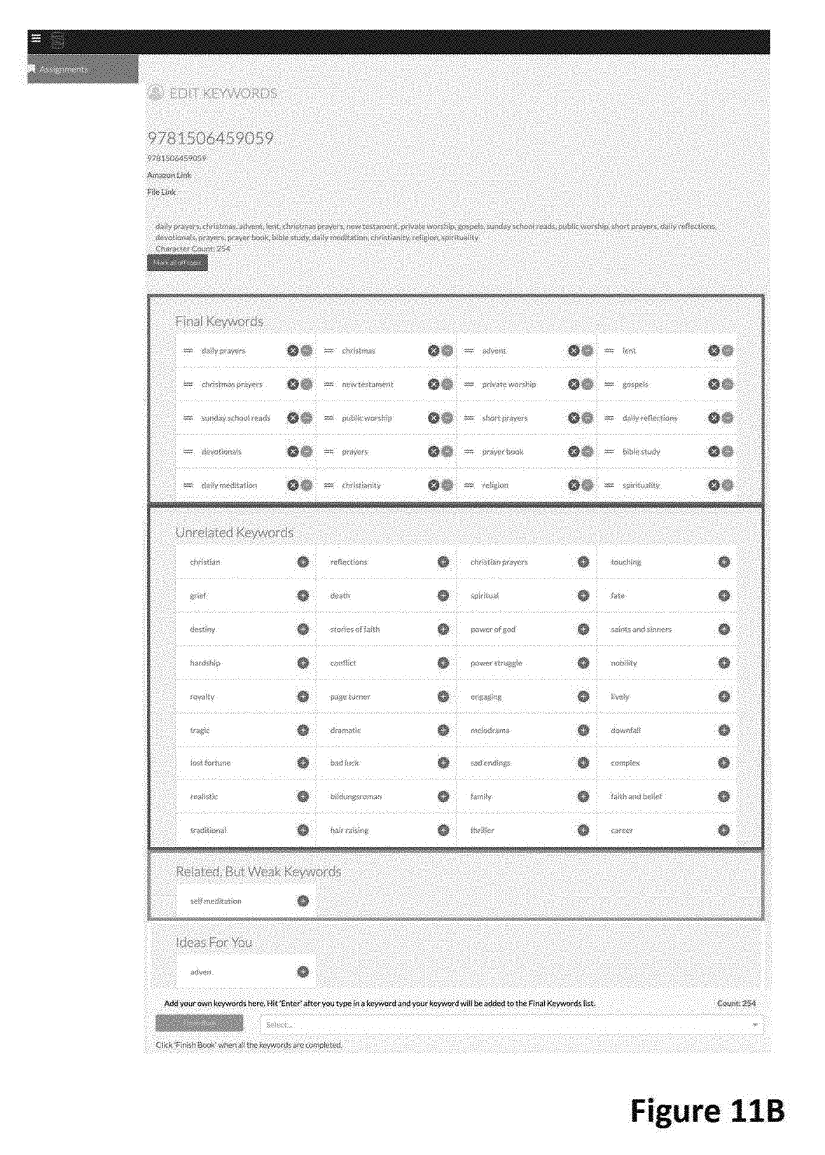

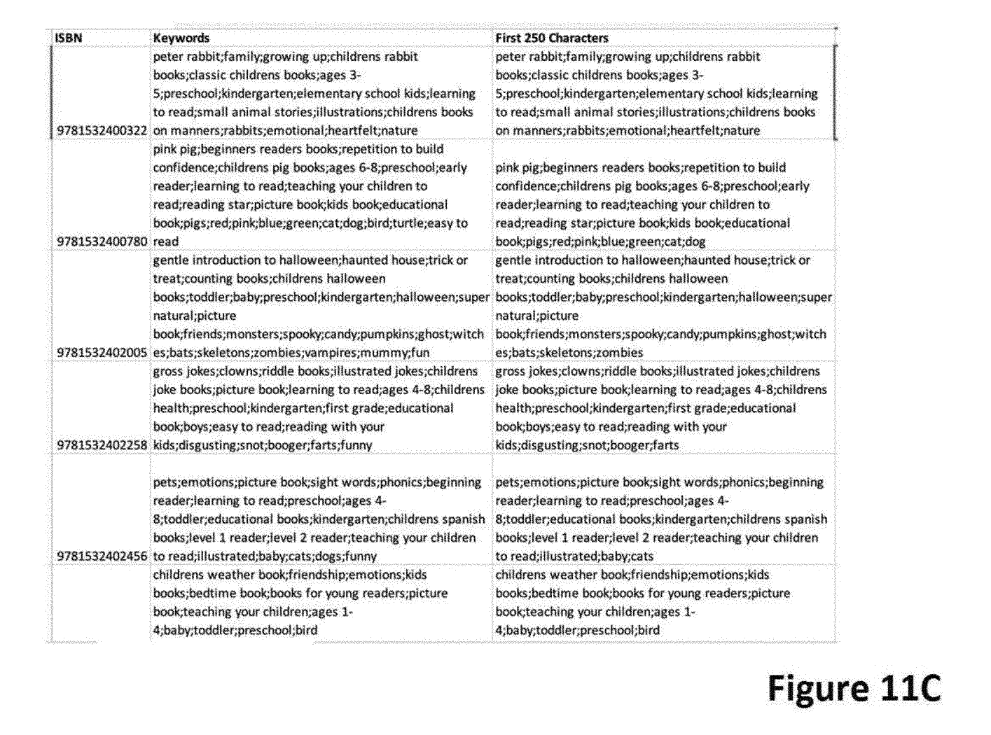

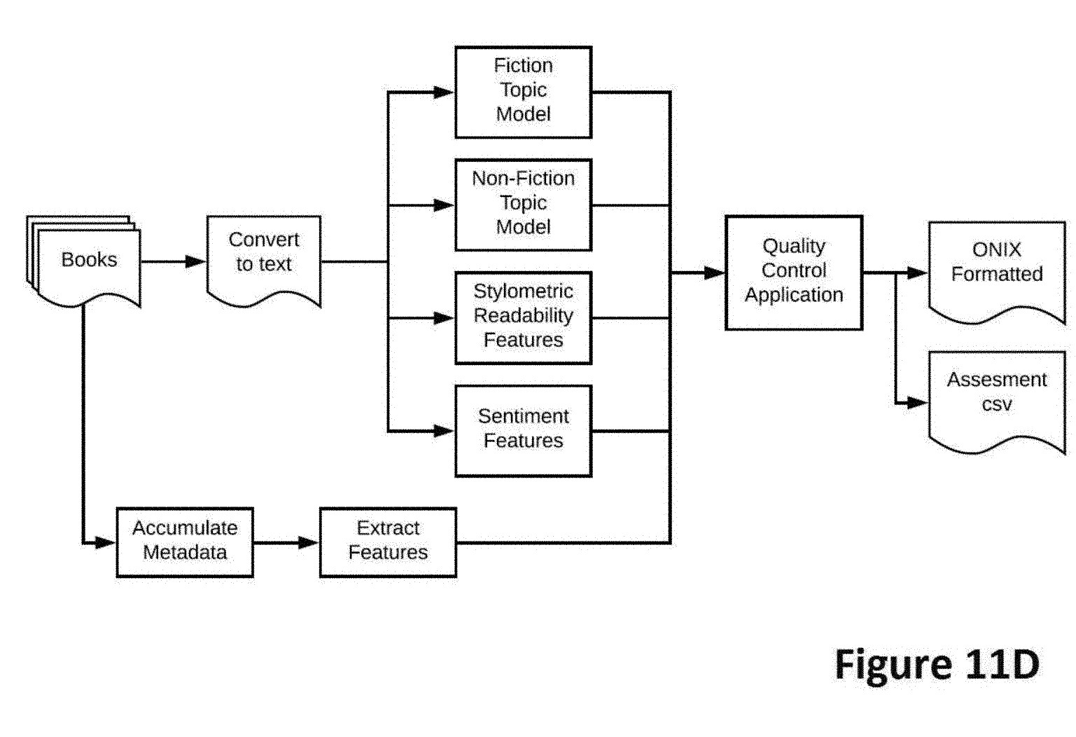

In terms of the books content processing, one embodiment, shown in FIG. 11A, illustrates steps of book keyword generation. In one example, a manuscript is selected and pre-processed. The manuscript may be processed to automatically classify each chapter and subsection of the book. Additionally, the performance analytics system component may automatically identify the gender, age, and other features of each character. A book processing ingestion pipeline may convert a manuscript into a structured, consistent format.

The performance analytics system component may generate a matrix of all titles by all keywords and perform various regression techniques to highlight high-performing keywords, based on various criteria, such as best sales or page view performance. The system may then re-weigh keywords across the entire corpus based on results of regressions and update the weights. This methodology may result in quarterly iteration on each title's keywords, where each book may be re-run through the system's processing pipeline to update its keywords.

The results may be output and delivered as a set of keywords per title up to a predetermined number of characters (e.g., 500), in accordance with metadata management systems parameters. Moreover, the clients may receive a list of their keyword sets per title in an Excel format, or any other format deemed suitable. The system may further integrate keywords into existing Content Management Systems (CMS).

In one example, step 1 of the book keyword generation includes manuscript pre-processing and subsequent feature extraction for the extracted features to be input into a database of features for comparison. In step 2, the extracted features may be analyzed through a natural language pipeline, and in step 3 the results may be returned to the database when the database is updated. Step 4 is the quality control (QC) portion of the book keyword generation, where manual keyword review may be performed. In step 5, the QC results may be returned to the database for the database to be updated. Step 6 includes generation of the optimized keyword set.

FIG. 11B presents an example of a keyword editor quality control interface, where the visuals for keyword assignment are shown. In one embodiment, as a book is added into the database system, the performance analytics system component processes the keywords and adds relevant keywords to the database. The added keywords may undergo quality control analysis, where a judgment may be made whether the machine generated keywords from the list are off topic or pertinent to the desired topic, for example. The irrelevant keywords may be removed from the list and replaced with other keywords that are deemed more relevant by a quality control manager. Subsequently, an updated keywords list may be created, as shown in FIG. 11C, which is an example output of the keyword quality control process. The updated list may further be formatted and structured by truncating the number of characters, and/or by semantically arranging the list of characters.

FIG. 11D exemplifies a flow chart of book scripted content metadata and content feature extraction. Initially, contents of a book may be converted to text, and the book's metadata may be preprocessed. In one example, the metadata is subsequently accumulated in preparation for feature extraction. Subsequently, the converted text file may be processed, by fiction topic modeling, non-fiction topic modeling, organizing stylometric readability features and/or sentiment feature. The processed data may further undergo quality control application, such as, for example, manual human verification of the processing results shown in FIG. 11B. In one embodiment, upon the quality control, the processed content and metadata features may be ONIX formatted, and in another embodiment, a structured format is created, such as an assessment.csv dataset shown in FIG. 11C, where multiple books are tagged into components, one book per row.

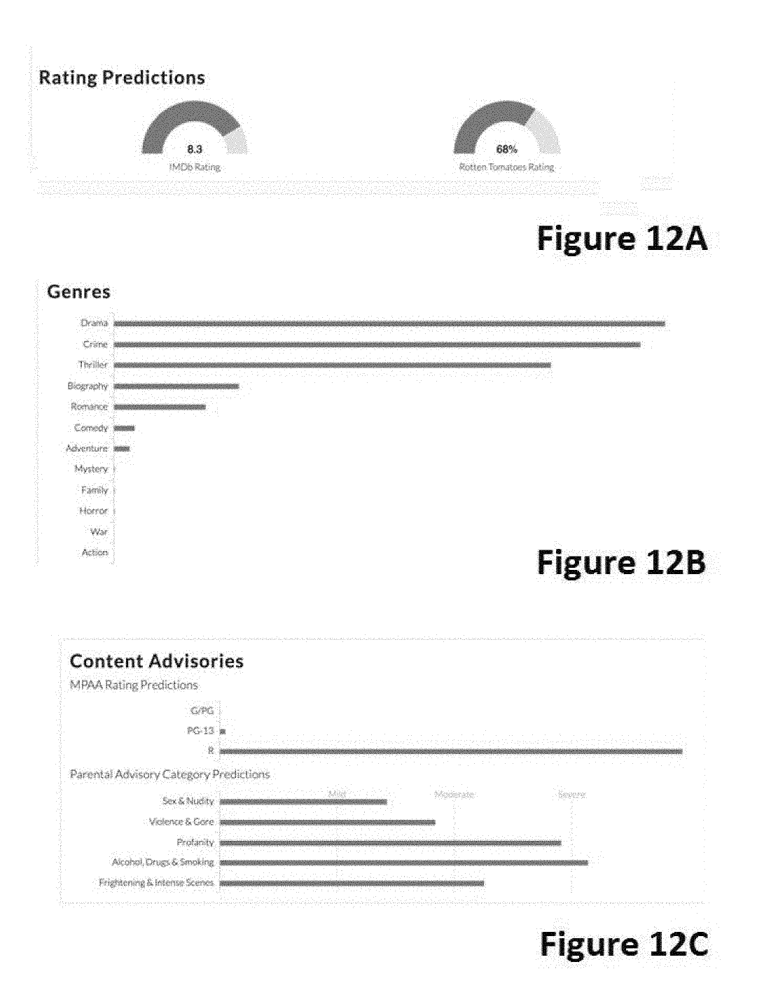

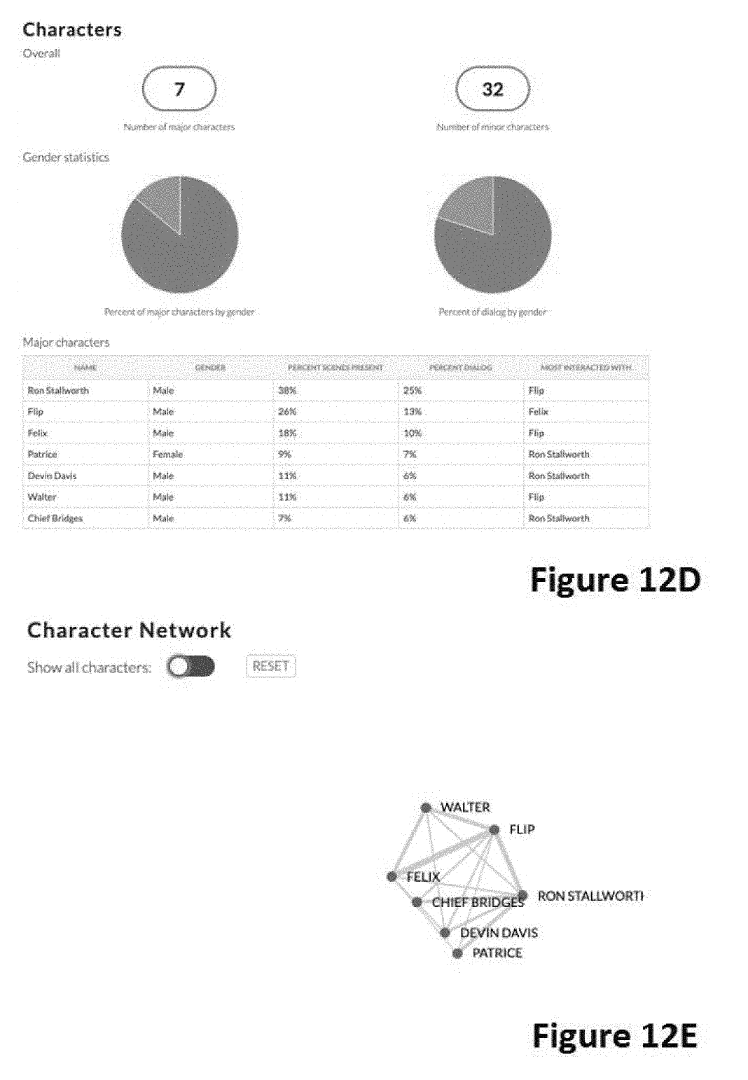

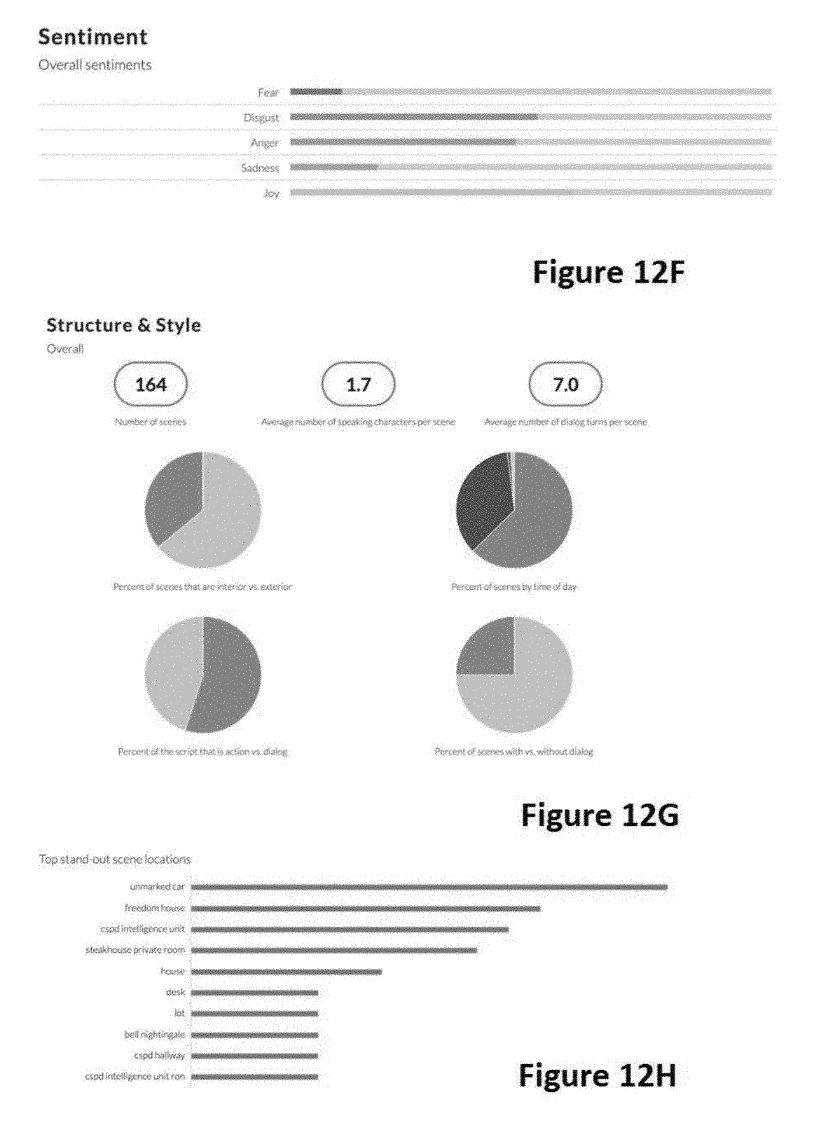

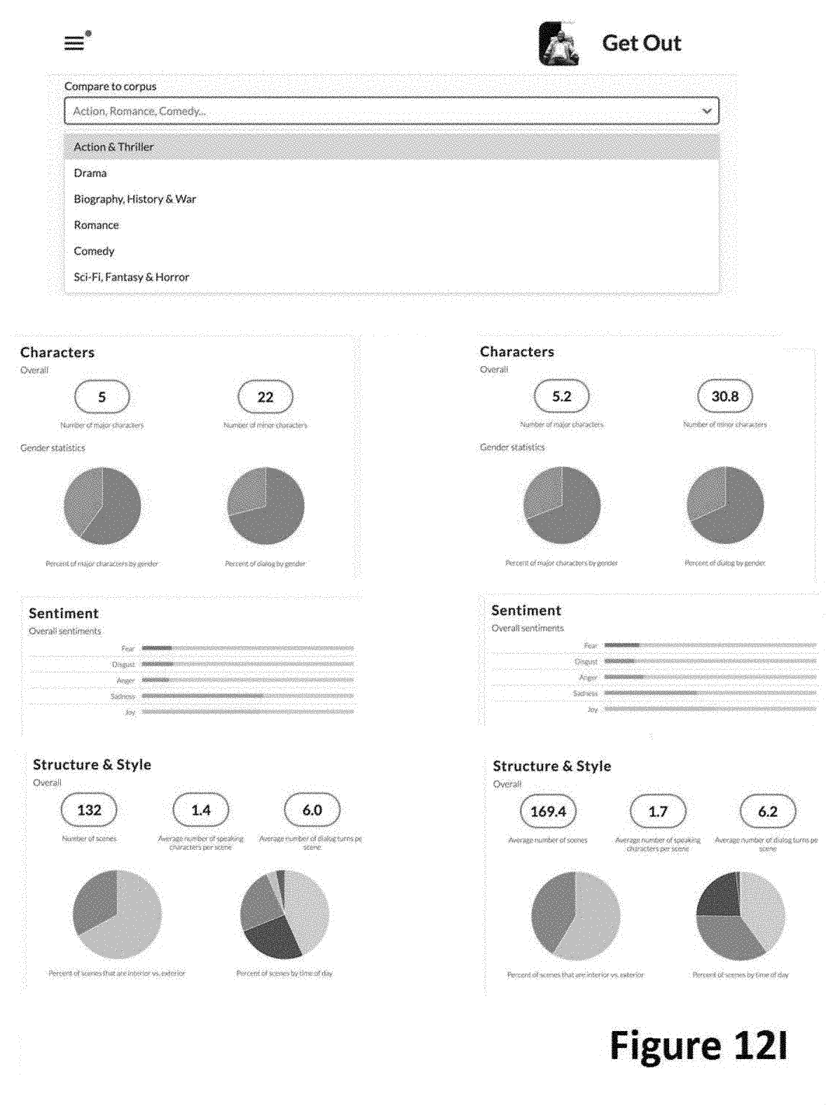

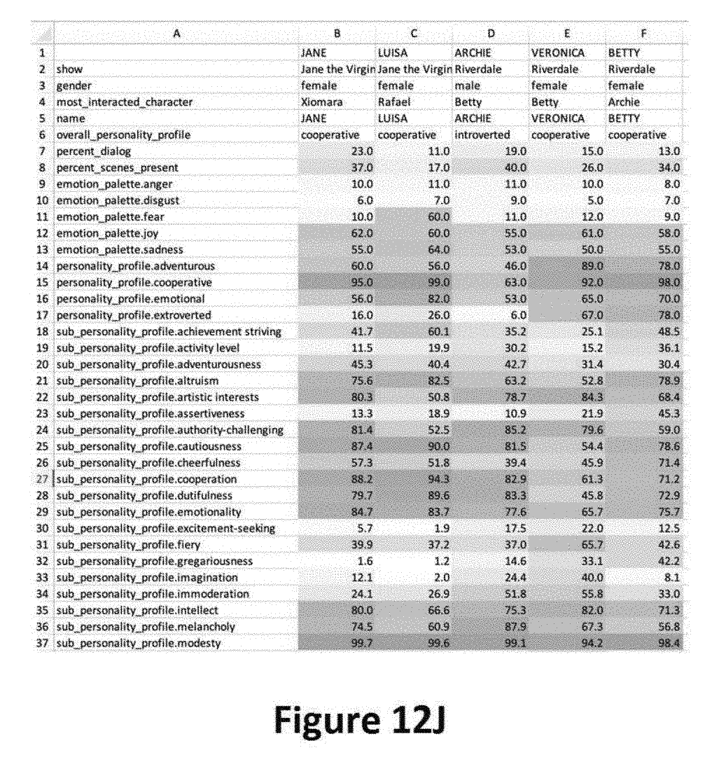

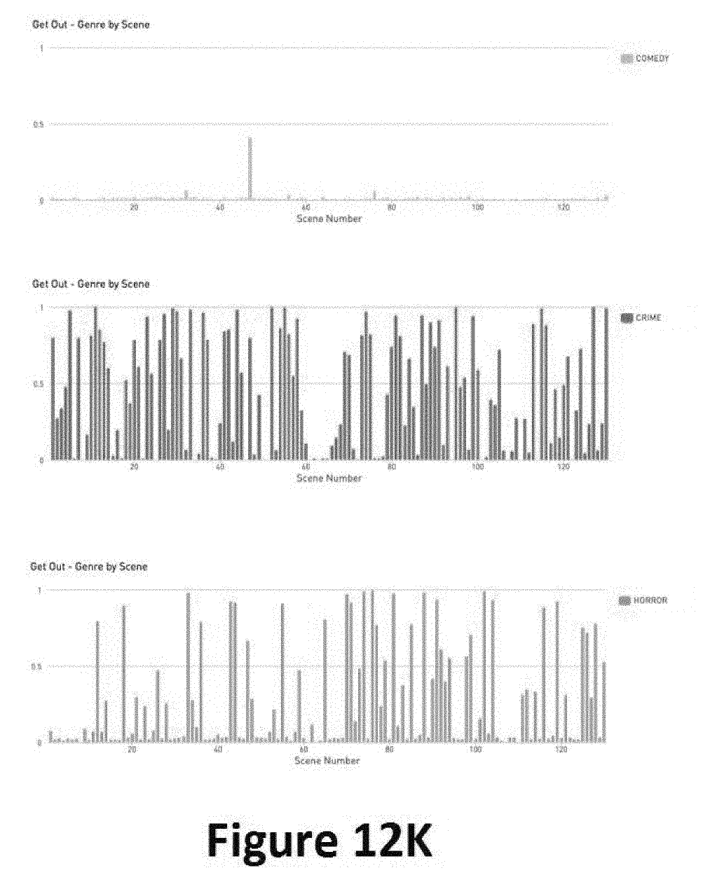

Another application of the performance analytics system is a display of screenplay insights, shown in FIGS. 12A-K. For example, a selected screenplay may be evaluated in terms of its predicted ratings, such as IMDb rating or Rotten Tomatoes rating, shown in FIG. 12A. In one embodiment, depicted in FIG. 12B, the screenplay content is processed to display how well it matches certain genres, and likelihoods that the analyzed screenplay belongs to specific genres is presented. FIG. 12C shows content advisories predictions, such as what the MPAA rating prediction is for the selected screenplay (e.g., G/PG, PG-13, R, etc.), or what parental advisory category the processed content belongs to.

Another example of screenplay insights is illustrated in FIGS. 12D and 12E. The performance analytics system component may create a dashboard that presents information about the characters in the screenplay, such as overall number of characters, number of major and minor characters, percent of major characters by gender, percent of dialog by gender, or details statistical data regarding individual characters, as presented in FIG. 12D. In addition, characters may be analyzed in terms of their mutual relationships and interaction in the selected screenplay and a network among selected characters may be created, such as the example included in FIG. 12E. In one example, the performance analytics component applies sentiment/personality detection models and performs character personality analysis for narrative content by measuring personality attributes of individual characters, and the emotion for each character.

FIG. 12F shows an embodiment of a dashboard displaying sentiments measured to be present within a processed screenplay, such as overall sentiments, and/or specific sentiments and their prevalence in the analyzed content. FIG. 12G exemplifies a display of structural and stylistic features of a processed content, such as number of scenes, average number of speaking characters/dialog turns per scene, percent of scenes: interior versus exterior, by the time of day, with versus without a dialog, action versus dialog, etc. One example of screenplay insights is a dashboard of top stand-out scene locations in a screenplay, as presented in FIG. 12H.

In one embodiment, the performance analytics system component performs a “corpus comparison” analysis and provides a dashboard with the results, such as the one shown in FIG. 12I. In one example, an interface allows for a corpus to be selected from a dropdown list that includes, for example, action and thriller, drama, biography/history/war, romance, comedy, or any other corpus of screenplays from the database deemed appropriate. Features of an input content may be analyzed and presented (left hand side in FIG. 12I) next to the features of the corpus averaged across the corpus data (right hand side in FIG. 12I). For instance, a user may visually determine how each feature of the selected screenplay compares with the computed results for the selected corpus.

FIG. 12J shows a grid that includes direct comparison among multiple characters. The characters may be a part of the same screenplay or they may be compared across different screenplays. In one example, all of the different features from each character are measured, and they are ordered by the percentage of each individual feature. In another example, overall personality profiles of each character are determined and presented. The relative differences in personality, emotion, and other attributes per character may be visualized in a heat map, for example. For example, note that “Luisa” in FIG. 12J is measurably higher in “fear” than other characters.

FIG. 12K shows an example of a display of features over narrative time, i.e., over the course of the screenplay. In the presented example the analyzed film is “Get Out,” and the presented feature is genre. Nonetheless, the display of features over narrative time may concentrate on other features of interest extracted from a screenplay, such as advisories per scene (sex and nudity, violence and gore, frightening and intense, alcohol and drugs, profanity, etc.), or MPAA rating per scene (PG13, PG/G, R, etc.) or any other feature deemed pertinent. In one embodiment, the narrative time may be measured by sequencing scenes in a screenplay and using a scene number as a unit of narrative time. The dashboard may include each individual genre (or other feature) score in each scene and present scenes with their corresponding scores for each genre, or may perform rolling averages over selected ranges of scenes (for example, rolling over 5 scenes).

In one embodiment, the display of features over narrative time may include multiple features (e.g. multiple sentiments, multiple action/dial tokens, etc.) in a same diagram plotted with respect to number of scenes, in order to visualize how the individual features compare with each other within each scene. In another embodiment, the performance analytics system component performs data normalization, which entails applying Fourier transform or other data transformations to the scene-by-scene information to create and display a smoothed curve in the context of narrative time.

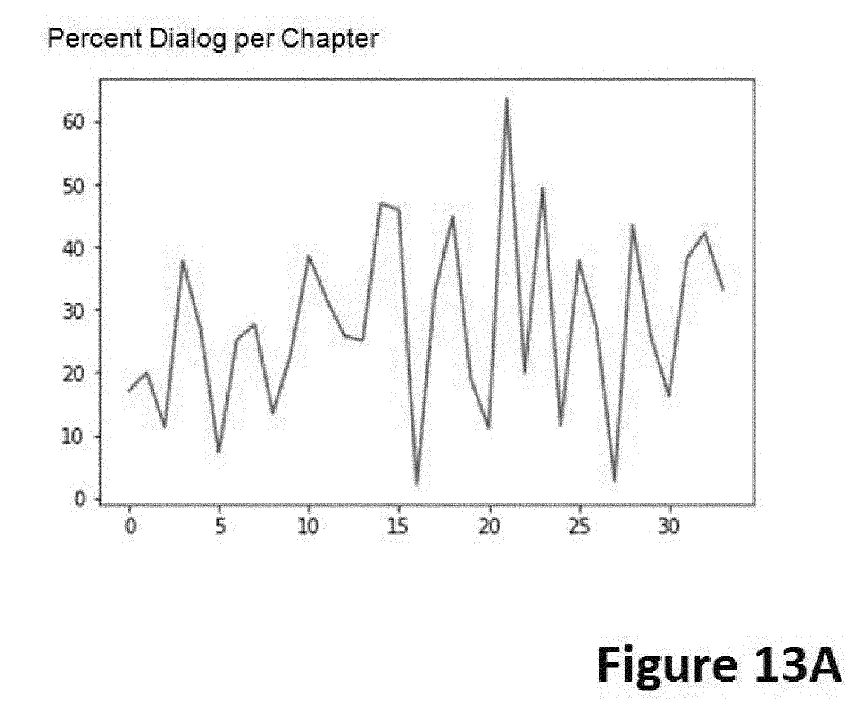

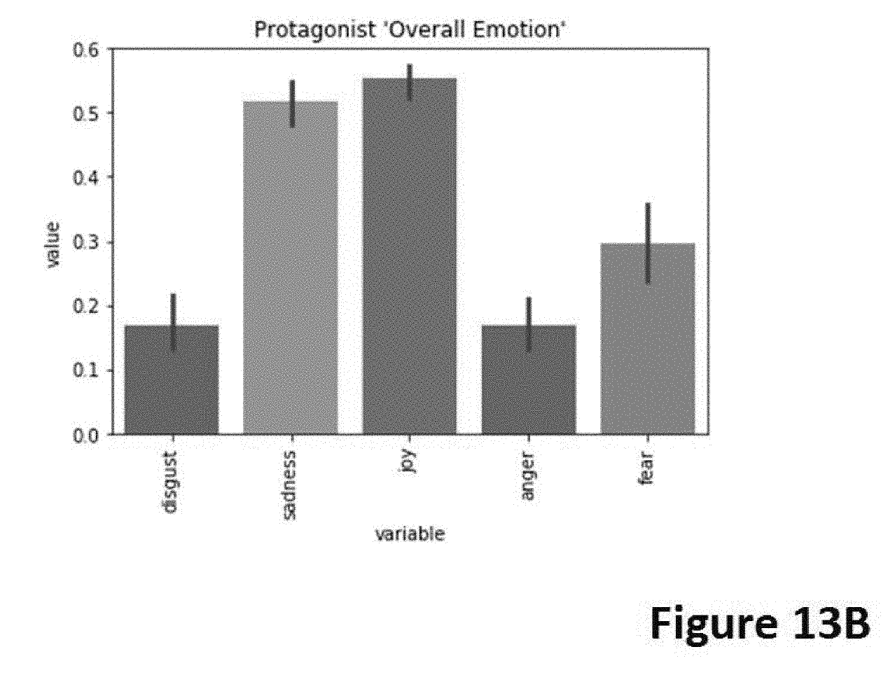

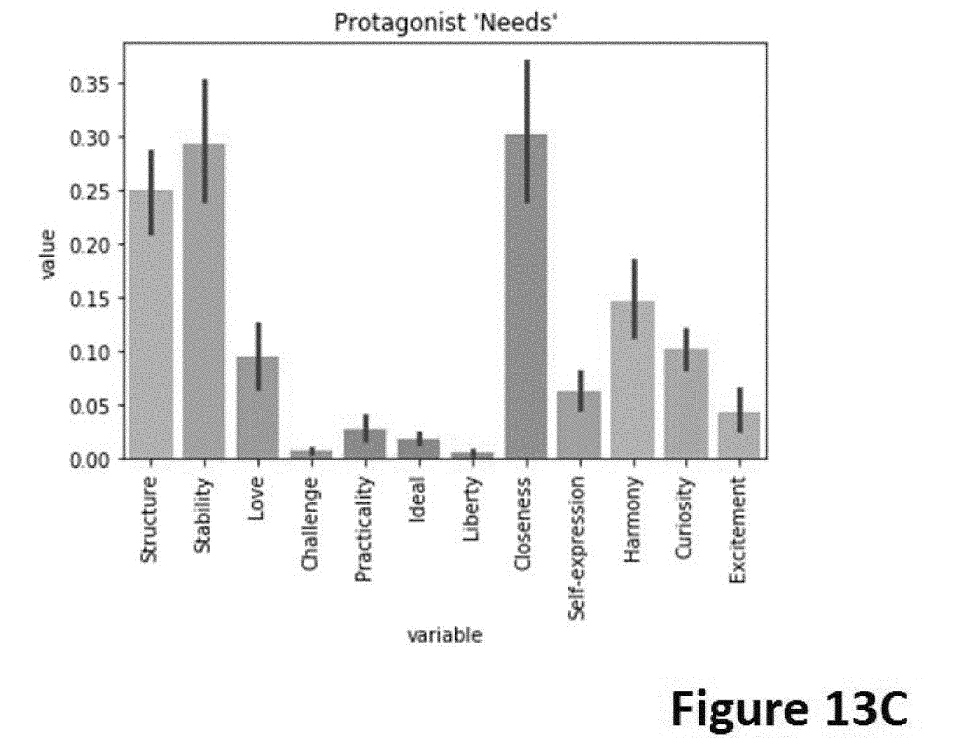

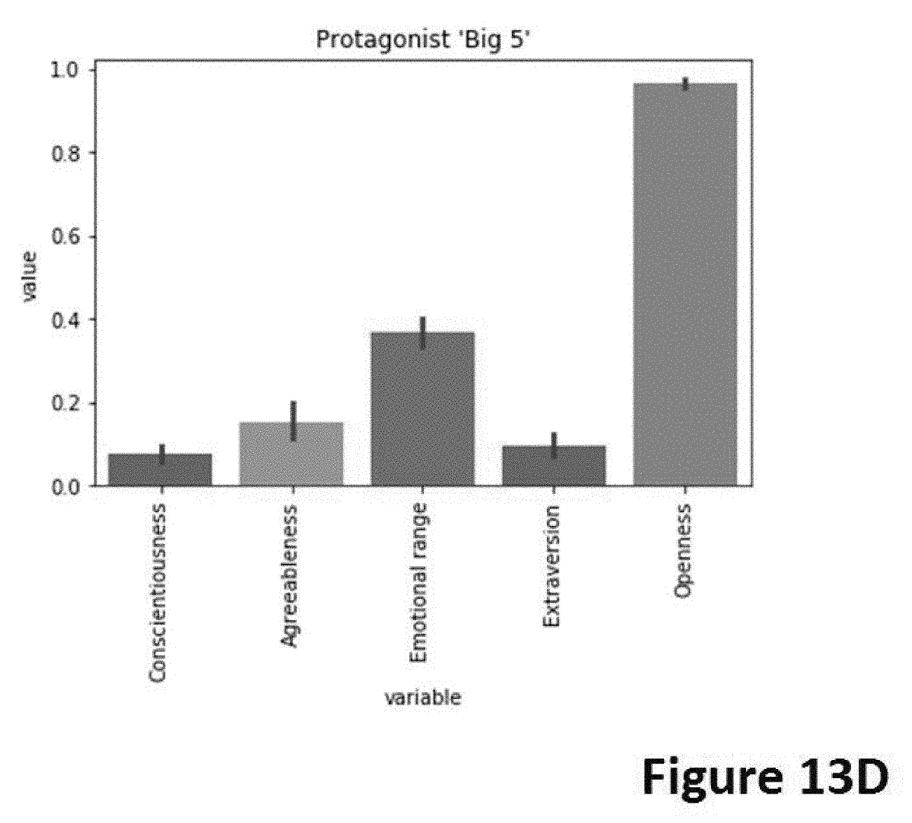

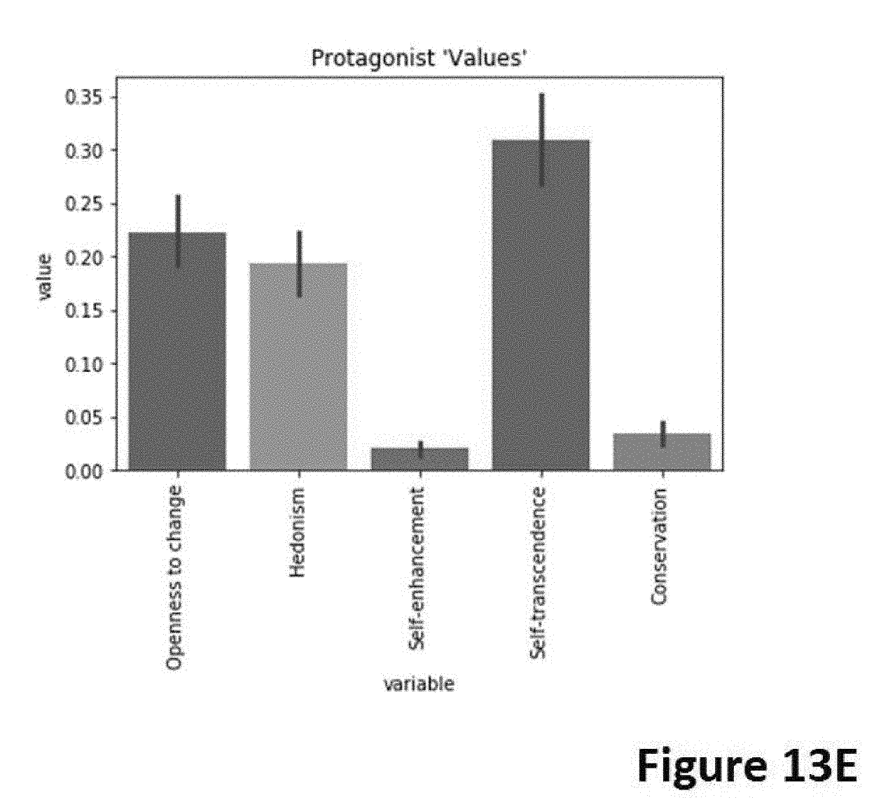

Yet another application of the performance analytics system is computing and displaying book insights, shown in FIGS. 13A-E. In one embodiment, the extracted features are visually presented with respect to the narrative time, such as number of chapters, for example. FIG. 13A shows an example of a display of percent dialogue per chapter for a selected book. Nonetheless, other features per chapter in a book may be displayed, such as protagonist positive/negative sentiment, protagonist emotion, or any feature considered pertinent. In one example of the performance analytics system, the values of the features scores are computed algorithmically per each chapter. The computed values may undergo quality control, such as reading the content of the book per chapter and comparing the computed values manually with the read content.

In one embodiment, a book is processed to determine a number of mentions of each character. In another embodiment, characters are analyzed in terms of their mutual relationships and interaction in the selected book, and a network among selected characters may be created, similar to the example included in FIG. 12E regarding a screenplay.

FIG. 13B shows an example of a display of a protagonist's overall emotion in a selected piece of scripted content, such as a book or a screenplay. In addition, FIG. 13C shows an example of a display of a protagonist's needs, FIG. 13D shows an example of a display of a protagonist's personality traits, and FIG. 13E shows an example of a display of a protagonist's values in a selected content.

In one embodiment, the performance analytics system component determines a change of each character in a scripted content throughout the sequence of the scripted content. For example, a protagonist's personality trait scores may be calculated in each chapter, and trends may be computed and displayed based on a change in the personality trait scores for the individual protagonist.

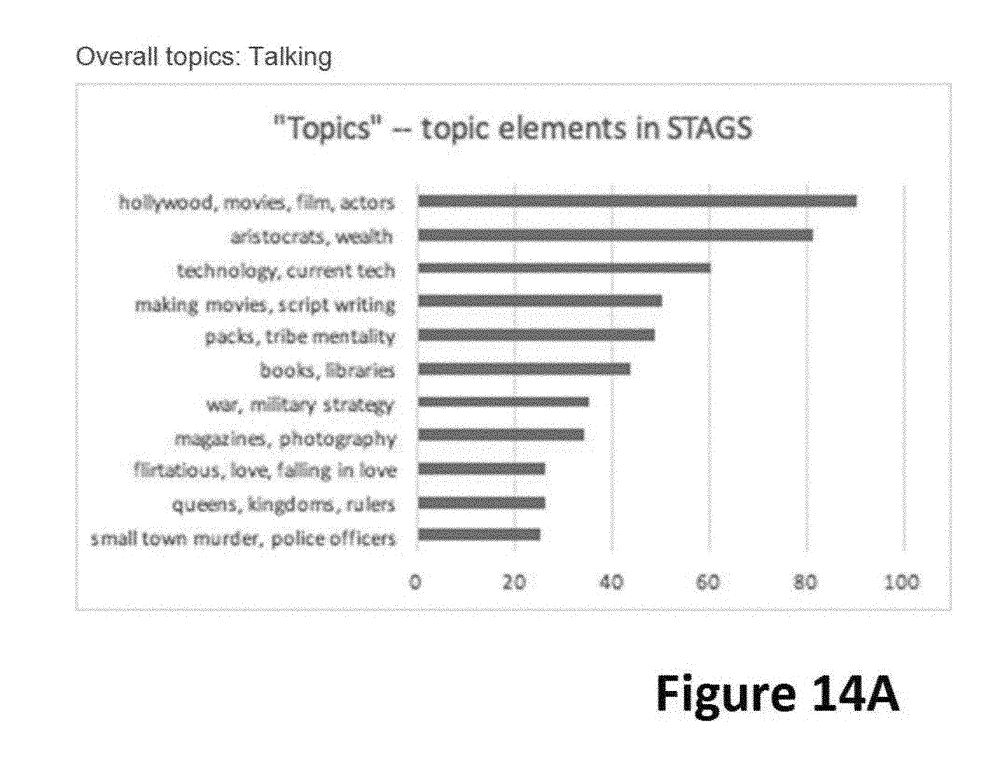

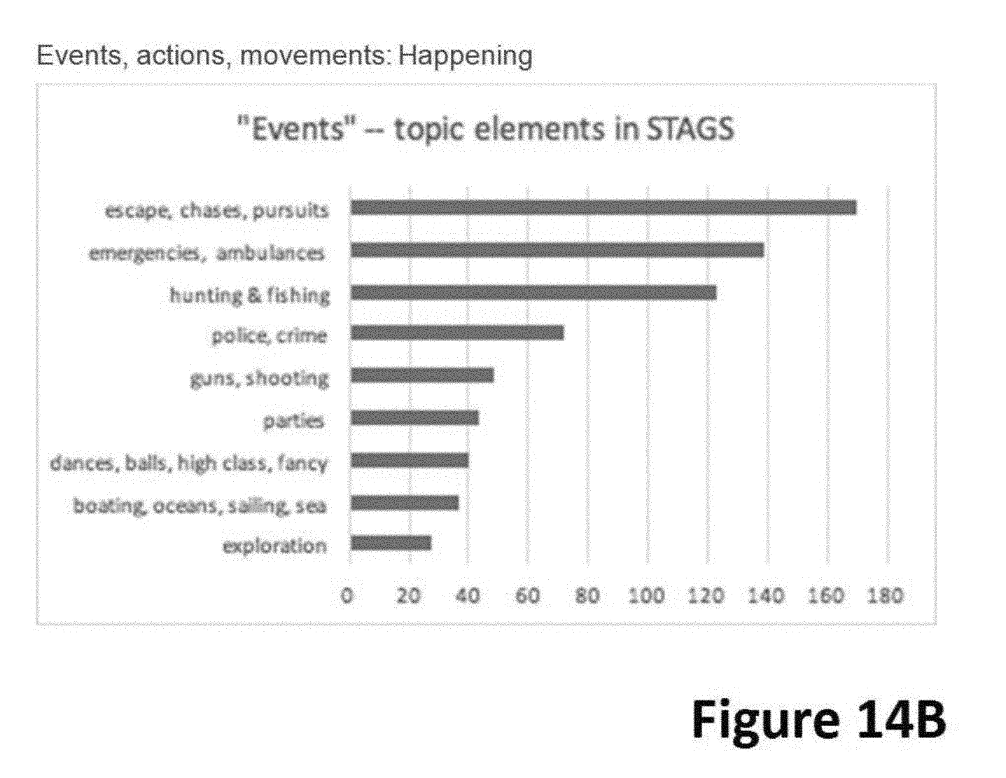

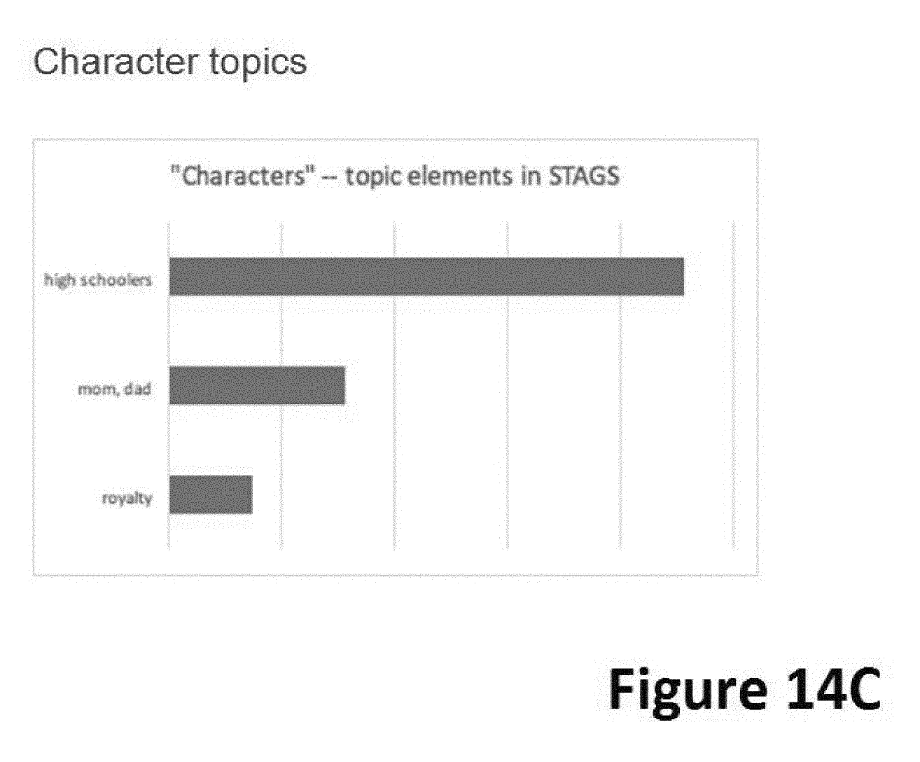

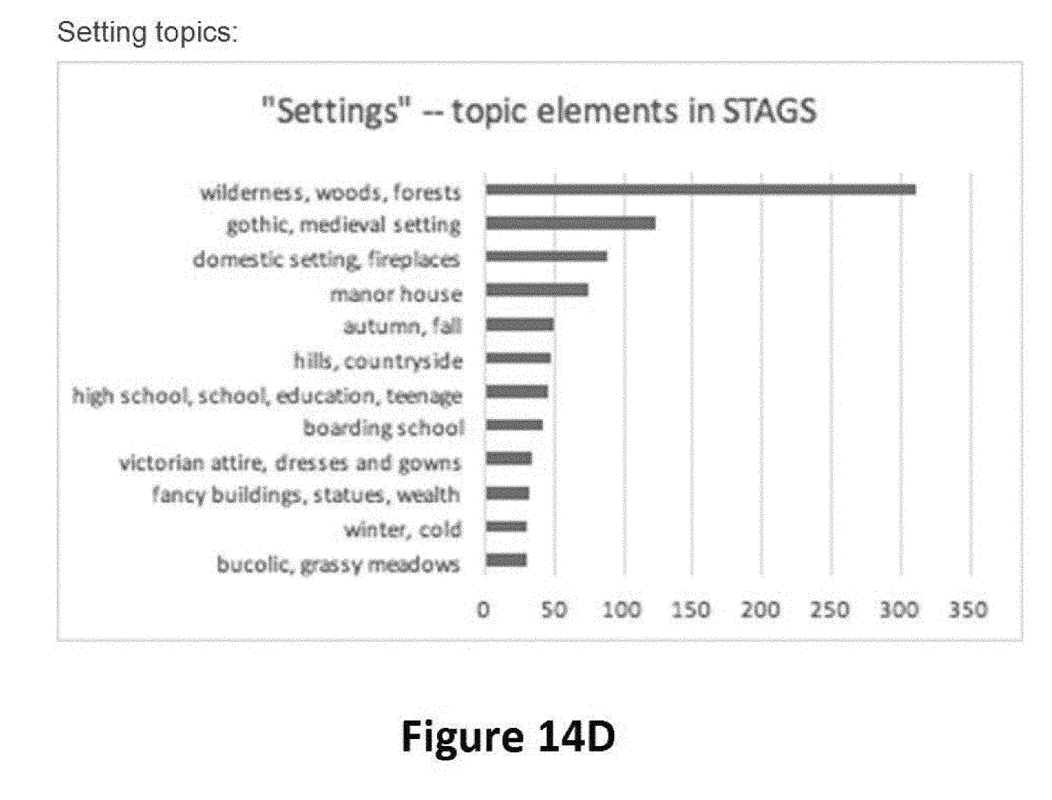

Another application of the performance analytics system is computing and displaying topics and themes, shown in FIGS. 14A-D. FIG. 14A shows an example of a display of topics in a selected piece of scripted content showing features verbally discussed within the content. FIG. 14B displays topic elements in a content that includes events, actions, and/or movements. FIG. 14C shows an example of character related topics in a selected content. FIG. 14D shows an example of setting topics in a selected content.

The performance analytics system component may detect geographic settings, such as countries, localities, regions, etc., based on their referencing in a book or a screenplay, or any other scripted content analyzed. In addition, the performance analytics system component may measure external references, such as media references, or technology references in a book or a film. The system may indicate an audience highly tuned in to social trends and popular media for young adults, as well as popular scripted content studied in educational institutions. For example, the external references may be compiled in a database to include a sampling of the frequent movie and culture references, as well as technology references, such as ‘BuzzFeed’, ‘Instagram’, ‘Snapchat’ ‘Facebook’, ‘Google’, ‘Pandora’, ‘iTunes’, ‘Twitter’, etc. Such references allow a user to position a particular scripted content on the market.

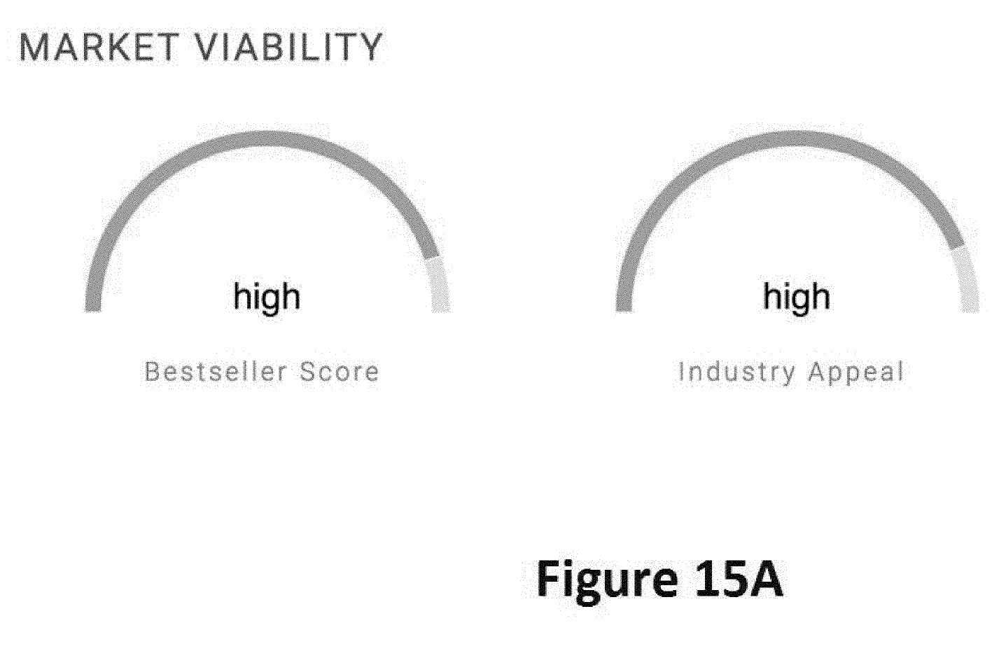

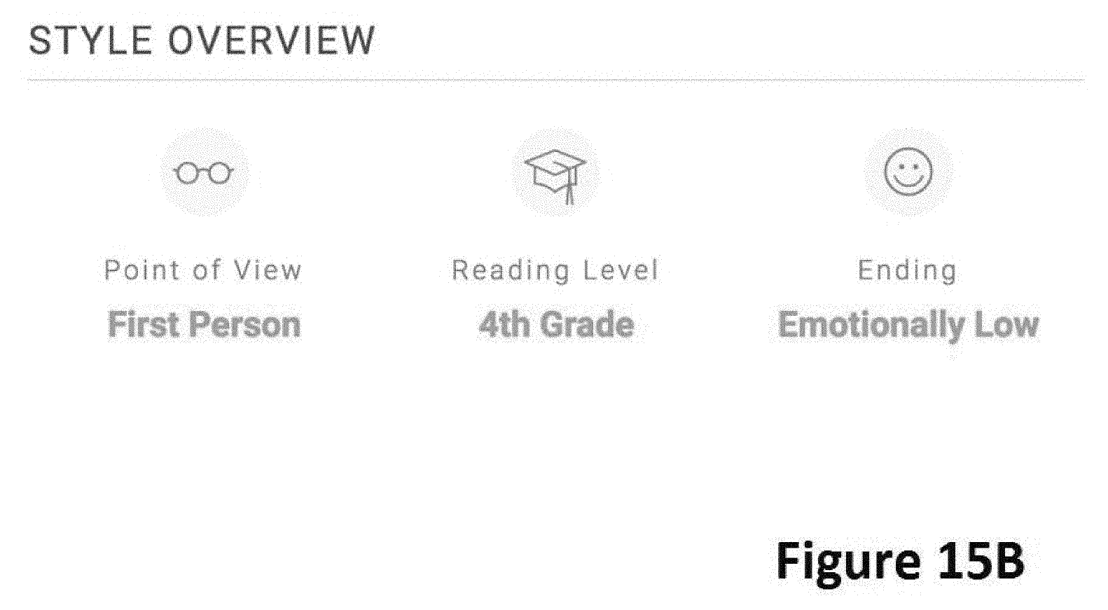

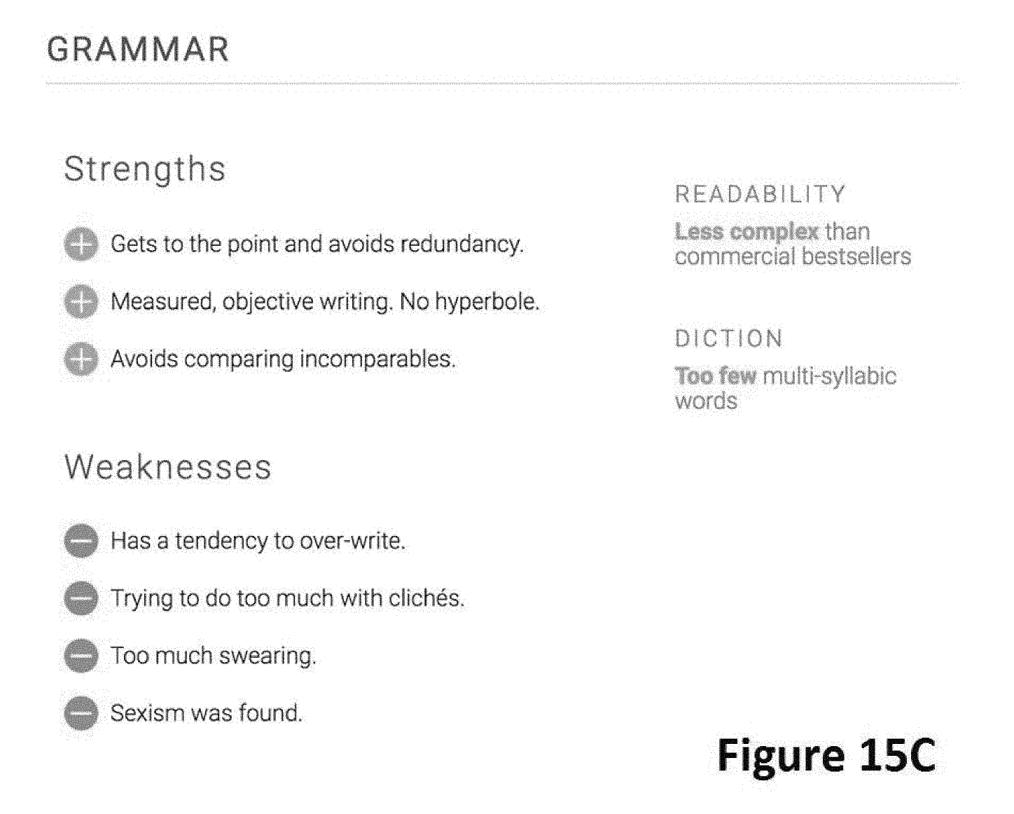

Another application of the performance analytics system is applying a variety of prediction models on a scripted content in order to compute and present prediction insights, as shown in FIGS. 15A-C. FIG. 15A shows an example of a display of results of a prediction market viability model which includes bestseller score and industry appeal for the analyzed content. FIG. 15B displays results of a style overview model, which includes a point of view insight, a reading level insight and an ending insight, e.g., emotionally high or low, etc. FIG. 15C shows an example of a dashboard that includes computation results of a grammar analysis model.

The above described performance analytics system provides numerous advantages over the conventional solutions. For example, the system includes universal data analysis and management for scripted media in multiple venues (e.g., publishing, film, television, gaming, etc.) for the purpose of extracting quantifiable attributes from content that can be used for both quantitative and qualitative analysis, as well as comparisons across product or project inventory. Additionally, a predictive, pre-production decision-making strategy/method is enabled by application of data analysis and reporting on content before it enters production phase.

The system enables comparative analysis across aggregated data sets by compiling data across industry sources unavailable to individual users. Secure data transfer of the content system maintains proprietary control of the intellectual property such as copyrights while comparing its attributes to other data sets. The described performance analytics system allows for analysis of multiple content types, for example, long and short form text, screenplays, stage plays, gaming scripts, etc. As a result, exposure and evaluation of unseen attributes in text that are beyond human cognition is available, for example, remembering every character, story arc, topic, theme, setting, or symbol across tens of thousands of pieces of media content. The system further unifies data with subsidiaries (imprints, production houses, third party content delivery) through collaboration and communication tools and shared channels. This facilitates standardization of the acquisitions process through the delivery of content from creator to buyer in a systematic, standardized format and provides a marketplace platform to access and manage prospective authors and their content.

Although the various systems, modules, functions, or components of the present invention may be described separately, in implementation, they do not necessarily exist as separate elements. The various functions and capabilities disclosed herein may be performed by separate units or be combined into a single unit. Further, the division of work between the functional units can vary. Furthermore, the functional distinctions that are described herein may be integrated in various ways.

The foregoing description and examples have been set forth merely to illustrate the invention and are not intended to be limiting. Each of the disclosed aspects and embodiments of the present invention may be considered individually or in combination with other aspects, embodiments, and variations of the invention. Modifications of the disclosed embodiments incorporating the spirit and substance of the invention may occur to persons skilled in the art and such modifications are within the scope of the present invention.

What is claimed is:

1. A networked computerized system for analyzing scripted content, comprising:
a plurality of networked, standalone, programmed devices; and
a network that connects the networked, standalone, programmed devices;
wherein each of the plurality of networked, standalone, programmed devices includes:
an interactive subsystem component that allows for input of scripted content data by at least one user or at least one partner;
a data storage subsystem component that stores the scripted content data input by the at least one user or at least one partner; and
a performance analytics component programmed to process the input scripted content data to produce a predictive or descriptive recommendation for analysis or for action to the at least one user or at least one partner,
wherein the performance analytics component includes a plurality of similarity computation algorithms.

2. The system of claim 1, wherein the interactive subsystem component outputs the recommendation for analysis or for action to the at least one user or at least one partner.

3. The system of claim 1, wherein the recommendation for action occurs at a pre-production or pre-acquisition stage of the scripted content.

4. The system of claim 1, wherein the similarity computation algorithms determine comparability based on features of the scripted content.

5. The system of claim 1, wherein the similarity computation algorithms determine comparability based on production details.

6. The system of claim 1, wherein the performance analytics component is programmed to process the input scripted content data by natural language processing.

7. The system of claim 1, wherein the processing of the input scripted content data includes sentiment identification and categorization.

8. The system of claim 7, wherein the sentiment identification and categorization comprises emotion extraction from the content data.

9. The system of claim 7, wherein the sentiment identification and categorization comprises tone details extraction from the content data.

10. The system of claim 7, wherein narrative characteristics and plot types are derived from the identified and categorized sentiment.

11. The system of claim 7, wherein an interactive subsystem component outputs a visual diagram of results presenting the identified and categorized sentiment.

12. The system of claim 7, wherein the data storage subsystem component includes a dictionary of tags correlating sentiments to natural language of the content data, and
wherein the sentiment identification and categorization includes using the dictionary of tags to map scripted content units to a corresponding sentiment value.

13. The system of claim 1, wherein the processing of the input scripted content data includes topic modeling that extracts topics from the scripted content data.

14. The system of claim 13, wherein the topic models are visually represented in a map.

15. The system of claim 13, wherein the extracted topics are mapped to their corresponding keywords.

16. The system of claim 1, wherein the data storage subsystem component maintains a database of keywords and metadata.

17. The system of claim 16, wherein the performance analytics component is programmed to track performance of the keywords.

18. The system of claim 17, wherein the performance analytics component is programmed to iteratively update the keywords based on the keyword performance.

19. The system of claim 16, wherein the performance analytics component is programmed to enrich the database of metadata and keywords by ingesting and processing the input scripted content data.

20. The system of claim 1, wherein the performance analytics component is further programmed to prepare the input scripted content data for processing by performing the following steps:
dividing the content data into logical units of storage,
adding the divided content data to the data storage subsystem component,
converting the divided content data into an extractable file form,
extracting metadata from the converted content data, and
storing the extracted metadata in a database.

21. The system of claim 20, wherein the preparation of the input scripted content data for processing further includes programming the performance analytics component to perform stylometry analysis on logical units of storage of the scripted content data.

22. The system of claim 21, wherein output of the stylometry analysis includes at least of one of the following: tone, pacing, and authorial attributes of the processed content data.

23. The system of claim 22, wherein the stylometry analysis includes readability analysis of the scripted content data.

24. The system of claim 1, wherein the performance analytics component is further programmed to tokenize the scripted content data using an internal dictionary of terms prior to tagging.

25. The system of claim 24, wherein the performance analytics component is further programmed to create the internal directory from terms derived from a corpus of scripted content.

26. The system of claim 1, wherein the performance analytics component is programmed to extract at least one plot arc from the scripted content data.

27. The system of claim 26, wherein the at least one extracted plot arc is categorized and organized based on archetypical plot types.

28. The system of claim 1, wherein the performance analytics component includes a plurality of machine learning algorithms.

29. The system of claim 28, wherein results computed by the machine learning algorithms are used as input for the similarity computation algorithms.

30. A networked computerized method for analyzing scripted content, comprising:
inputting scripted content data by at least one user or at least one partner by using an interactive subsystem component;
storing the scripted content data input by the at least one user or at least one partner by using a data storage subsystem component; and
processing the input scripted content data to produce a predictive or descriptive recommendation for analysis or for action to the at least one user or at least one partner by using a performance analytics component,
wherein the performance analytics component includes a plurality of similarity computation algorithms.

31. The method of claim 30, wherein the similarity computation algorithms determine comparability based on at least one of the following: setting, character, style, topics, sentiment, budget, and cast.

32. The method of claim 30, wherein the method further comprises preparing the input scripted content for processing by performing the following steps:
dividing the content data into logical units of storage,
adding the divided content data to the data storage subsystem component,
converting the divided content data into an extractable file form,
extracting metadata from the converted content, and
storing the extracted metadata in a database.

33. The method of claim 32, wherein the method further comprises migrating the prepare scripted content from a customer-facing storage system to an internal database.

34. A machine learning method for analyzing scripted content, comprising:
inputting scripted content data by at least one user or at least one partner by using an interactive subsystem component;
storing the scripted content data input by the at least one user or at least one partner by using a data storage subsystem component; and
processing the input scripted content data to produce a predictive or descriptive recommendation for analysis or for action to the at least one user or at least one partner by using a performance analytics component,
wherein the performance analytics component includes a plurality of machine learning algorithms.

35. The method of claim 34, wherein the plurality of machine learning algorithms comprises neural network algorithms.

36. The method of claim 34, wherein the performance analytics component includes a plurality of similarity computation algorithms, and
wherein results computed by the machine learning algorithms are used as input for the similarity computation algorithms.

37. The method of claim 34, wherein the performance analytics component is programmed to extract metadata from the scripted content and input the extracted metadata in the plurality of machine learning algorithms.

38. A decision support system for analyzing scripted content, comprising:
an interactive subsystem component that allows for input of scripted content data by at least one user or at least one partner;
a data storage subsystem component that stores the scripted content data input by the at least one user or at least one partner; and
a performance analytics component programmed to process the input scripted content data to produce a predictive or descriptive recommendation for analysis or for action to the at least one user or at least one partner,
wherein the performance analytics component includes a plurality of similarity computation algorithms.

39. A data processing method for processing scripted content, comprising:
inputting scripted content data by at least one user or at least one partner by using an interactive subsystem component;
storing the scripted content data input by the at least one user or at least one partner by using a data storage subsystem component; and
processing the input scripted content data to produce a predictive or descriptive recommendation for analysis or for action to the at least one user or at least one partner by using a performance analytics component,
wherein the performance analytics component includes a plurality of similarity computation algorithms.
